(19) United States
(12) Patent Application Publication
(10) Pub. No.: US 2026/0003402 A1
(43) Pub. Date: Jan. 1, 2026

(54) ELECTRONIC DEVICE CAPABLE OF CHANGING STATE AND METHOD FOR OPERATING THE SAME

(71) Applicant: SAMSUNG ELECTRONICS CO., LTD., Suwon-si (KR)

(72) Inventors: Hyemi YU, Suwon-si (KR); Hyunggwang KANG, Suwon-si (KR); Moonsoo KIM, Suwon-si (KR); Jihun MUN, Suwon-si (KR); Hyungjin SON, Suwon-si (KR); Nagyeom YOO, Suwon-si (KR)

(73) Assignee: SAMSUNG ELECTRONICS CO., LTD., Suwon-si (KR)

(21) Appl. No.: 19/265,738

(22) Filed: Jul. 10, 2025

Related U.S. Application Data
(63) Continuation of application No. PCT/KR2025/007141, filed on May 27, 2025.

(30) Foreign Application Priority Data
Jun. 28, 2024 (KR) 10-2024-0085738
Jul. 26, 2024 (KR) 10-2024-0099398

(51) Int. Cl. G06F 1/16; H04M 1/02; H04N 21/431

(52) U.S. Cl. CPC G06F 1/1652; G06F 1/1624; H04M 1/0268; H04N 21/4314

(57) ABSTRACT

An electronic device comprises: a display module comprising a flexible display having a display size that is expandable and contractible; memory storing instructions; and at least one processor operatively coupled to the memory and the display module, wherein the instructions, when executed individually and/or collectively by at least one processor, cause the electronic device to: determine, using a first artificial intelligence model, a use pattern of a user of the electronic device according to a use environment, detect the display size of the flexible display based on a change in a state of the display module, and perform, using a second artificial intelligence model, layout optimization based on the use pattern and the display size.

### CROSS-REFERENCE TO RELATED APPLICATIONS

This application is a continuation of International Application No. PCT/KR2025/007141 designating the United States, filed on May 27, 2025, in the Korean Intellectual Property Receiving Office, and claiming priority to Korean Patent Application Nos. 10-2024-0085738, filed on Jun. 28, 2024, and 10-2024-0099398, filed on Jul. 26, 2024, in the Korean Intellectual Property Office, the disclosures of which are incorporated by reference herein in their entireties.

### BACKGROUND

### 1. Field

The disclosure relates to an electronic device capable of changing states and more specifically, to an electronic device performing layout optimization and a method for operating the same.

### 2. Description of Related Art

More and more services and additional functions are being provided via electronic devices (e.g., smartphones, or other portable electronic devices). To meet the needs and increase efficiency of electronic devices for various types of users, communication service carriers and/or device manufacturers are jumping into competitions to develop electronic devices with differentiated and diversified functionalities. Accordingly, functions being provided by electronic devices are evolving more and more.

Recently, slidable electronic devices with a variable screen size as well as the conventional bar type are attracting attention. Slidable electronic devices are designed to adjust (e.g., expand or contract) the screen size according to user's needs thereby providing expanded usability compared to conventional bar-type electronic devices with a fixed screen size. For example, users may perform simple tasks on a small (e.g., non-expanded) screen and multitasking with various contents on a large screen.

When the screen size expands or contracts in the slidable electronic device, if the screen layout is fixed, the usability of the slidable electronic device may be reduced. Therefore, adaptive and dynamic layout optimization according to a change in the screen size of the slidable electronic device is required.

### SUMMARY

According to an example embodiment, an electronic device and a method for operating the same may provide a user interface adaptive to various use environments and user's use patterns by optimizing the layout of a home screen, an application (app) screen, or a lock screen as the display size expands or contracts.

According to an example embodiment, an electronic device may comprise: a display module comprising a flexible display having a display size that is expandable and contractible; memory storing instructions; and at least one processor operatively coupled to the memory and the display module. The instructions, when executed individually and/or collectively by at least one processor, may cause the electronic device to perform at least one operation. The at least one operation may comprise determining, using a first artificial intelligence model, a use pattern of a user of the electronic device according to a use environment. The at least one operation may comprise detecting the display size of the flexible display based on a change in a state of the display module. The at least one operation may comprise performing, using a second artificial intelligence model, layout optimization based on the use pattern and the display size.

According to an example embodiment, a method for operating an electronic device may comprise at least one operation. The at least one operation may comprise determining, using a first artificial intelligence model, a use pattern of a user of the electronic device according to a use environment. The at least one operation may comprise detecting a display size of a flexible display of a display module based on a change in a state of the display module, wherein the display size of the flexible display is expandable and contractible. The at least one operation may comprise performing, using a second artificial intelligence model, layout optimization based on the use pattern and the display size.

According to an example embodiment, an electronic device and a method for operating the same may enable efficient use of a screen space by optimizing the layout of a home screen, an app screen, or a lock screen as the display size expands or contracts.

Further, according to an example embodiment, an electronic device and a method for operating the same may provide a user interface adaptive to the user's intention to change the screen size or a use scenario for each context by learning the user's use patterns and analyzing various use environments using an artificial intelligence model.

Further, according to an example embodiment, an electronic device and a method for operating the same may inform the user of a change in a user interface according to layout optimization by displaying a layout optimization execution queue via the display when performing layout optimization.

Therefore, according to an example embodiment, an electronic device and a method for operating the same may increase the usability of a slidable electronic device and maximize user convenience and user satisfaction.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a block diagram illustrating an example electronic device in a network environment according to one or more embodiment(s);

FIG. 2A is a top plan view illustrating an example electronic device in a first state;

FIG. 2B is a bottom view illustrating an example electronic device in a first state;

FIG. 2C is a plan view illustrating an example electronic device in a second state;

FIG. 2D is a bottom view illustrating an example electronic device in a second state;

FIG. 3 is a flowchart illustrating example operations of an electronic device according to one or more embodiment(s);

FIGS. 4A and 4B are views illustrating an example of layout optimization performed on a home screen of an electronic device according to one or more embodiment(s);

FIGS. 5A to 5C are views illustrating an example of layout optimization performed on an app screen of an electronic device according to one or more embodiment(s);

FIG. 6 is a view illustrating an example of layout optimization performed on a lock screen of an electronic device according to one or more embodiment(s);

FIG. 7 is a view illustrating an example of layout optimization for an app icon by an electronic device according to one or more embodiment(s);

FIG. 8 is a view illustrating an example of layout optimization for app foldering by an electronic device according to one or more embodiment(s);

FIG. 9 is a view illustrating an example of layout optimization for a widget by an electronic device according to one or more embodiment(s);

FIGS. 10A and 10B are views illustrating an example of layout optimization for a wallpaper by an electronic device according to one or more embodiment(s);

FIG. 11 is a view illustrating an example of layout optimization considering a wallpaper image by an electronic device according to one or more embodiment(s);

FIG. 12 is a view illustrating an example of layout optimization for a status bar by an electronic device according to one or more embodiment(s);

FIG. 13 is a flowchart illustrating an example operation of performing layout optimization based on a state change intention by an electronic device according to one or more embodiment(s);

FIG. 14 is a view illustrating an example of layout optimization performed during the execution of a music app by an electronic device according to one or more embodiment(s);

FIG. 15 is a view illustrating an example of layout optimization performed during the execution of a phone app by an electronic device according to one or more embodiment(s);

FIG. 16 is a view illustrating an example of layout optimization performed during the execution of an Internet app by an electronic device according to one or more embodiment(s);

FIGS. 17A and 17B are views illustrating an example of layout optimization performed during the execution of a navigation app by an electronic device according to one or more embodiment(s);

FIG. 18 is a view illustrating an example of a settings window for layout optimization of an electronic device according to one or more embodiment(s);

FIG. 19 is a flowchart illustrating an operation of displaying a layout optimization execution queue by an electronic device according to one or more embodiment(s); and

FIGS. 20A to 20D are views illustrating an example of a layout optimization execution queue of an electronic device according to one or more embodiment(s).

### DETAILED DESCRIPTION

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The term “and/or” may denote a combination(s) of a plurality of related components as listed or any of the components.

Hereinafter, the working principle and embodiments of the disclosure are described with reference to the accompanying drawings.

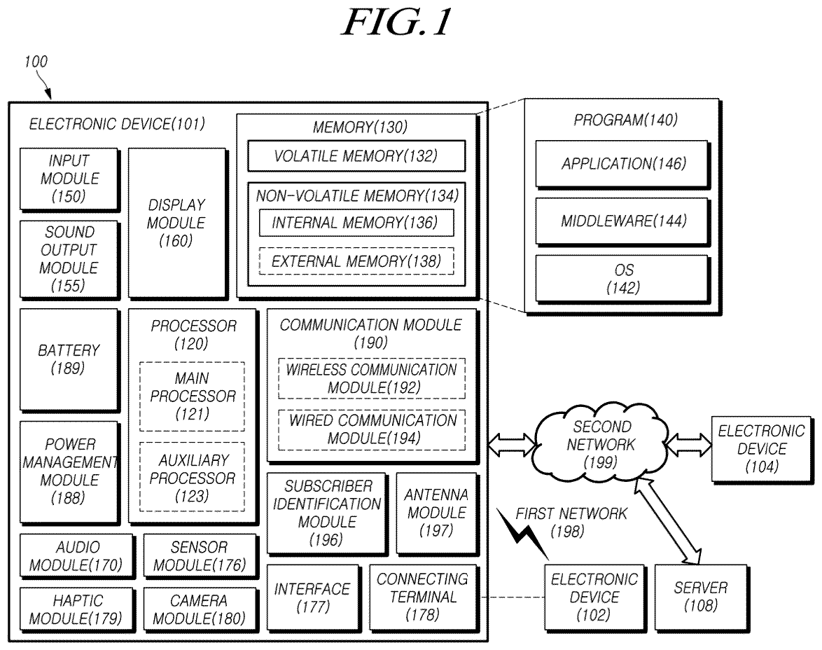

FIG. 1 is a block diagram illustrating an example electronic device in a network environment according to one or more embodiment(s).

In FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various functions of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120 and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102) (e.g., a speaker or a headphone) directly (e.g., wired) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wired) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a communication module 192 (e.g., a cellular communication module, a short-range communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The communication module 192 may identify or authenticate the electronic device 101 in a communication network, such as the first network 198 or the second network 199, using subscriber information (e.g., international mobile subscriber identity (IMSI)) stored in the subscriber identification module 196.

The communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The communication module 192 may support a high-frequency band (e.g., the mm Wave band) to achieve, e.g., a high data transmission rate. The communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The communication module 192 may support various requirements specified in the electronic device 101, an external electronic device (e.g., the electronic device 104), or a network system (e.g., the second network 199). According to an embodiment, the communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

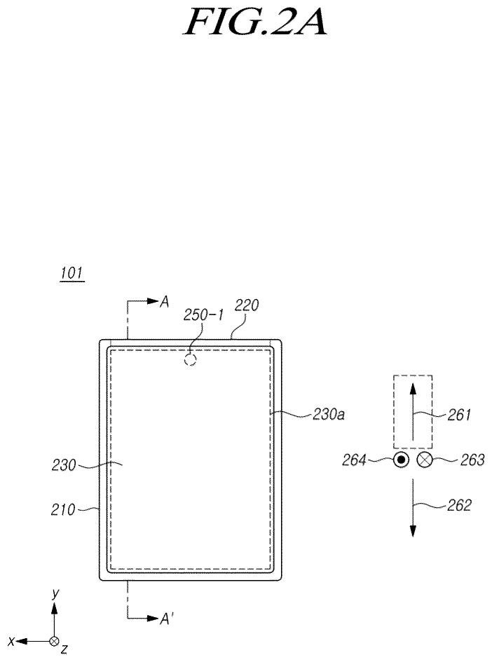

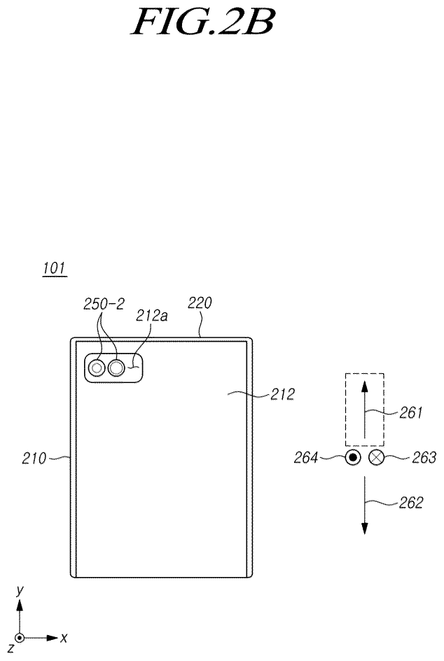

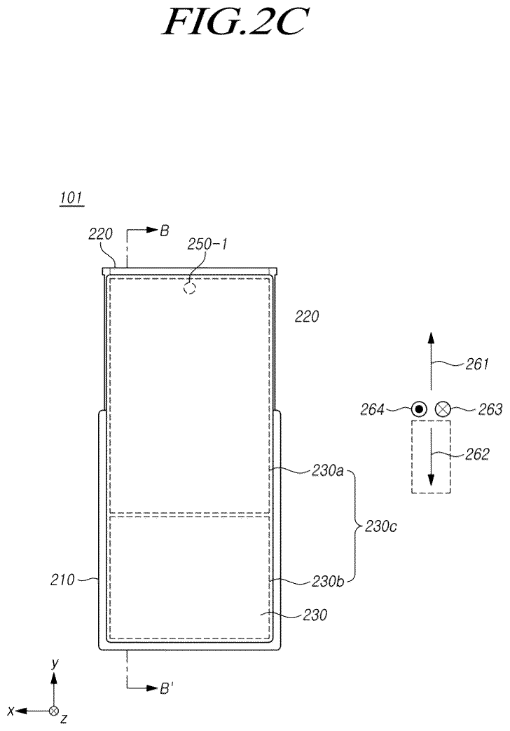

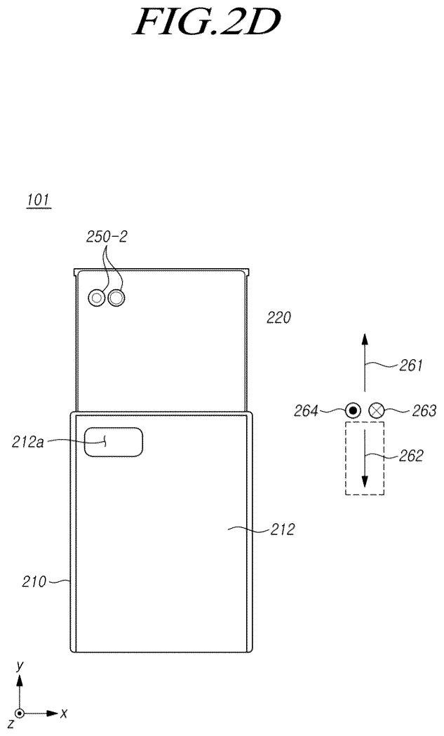

The display module 160 of the disclosure may be flexible. The display module 160 may be LCD (liquid-crystal display), LED (light-emitting diode), OLED (organic light-emitting diode), or any other suitable display known to one of ordinary skill in the art. The display module 160 may provide at least a portion of the outer surface of the electronic device 101 and may include a display area visually exposed outside the housing of the electronic device 101. For example, since the display module 160 has flexibility, at least a portion of the display module 160 may be rolled into the housing or slid into the housing. For example, the size of the display area may be changed according to the size of at least one portion of the display module 160 that is rolled into the housing or slid into the housing. For example, the electronic device 101 including the display module 160 may be in a plurality of states including a first state providing the display area having a first size and a second state providing the display area having a second size different from the first size. For example, the first state may be illustrated via the description of FIGS. 2A and 2B.

FIG. 2A is a top plan view illustrating an example electronic device 101 in a first state.

In FIG. 2A, the electronic device 101 may include a first housing 210, a second housing 220 that is movable with respect to the first housing 210 in a first direction 261 parallel to the y-axis, or a second direction 262 parallel to the y-axis and opposite to the first direction 261, and a display 230 (e.g., the display module 160 of FIG. 1). The first housing 210 and the second housing 220 may be the same size or different sizes. In one or more examples, the first housing 210 and the second housing 220 may be purchased separately and connected to each other to form a flexible display. In one or more examples, the first housing 210 and the second housing 220 may have a same screen type. In one or more examples, the first housing 210 and the second housing 220 may have different screen types. For example, the first housing 210 may have an LED screen and the second housing may have an OLED screen. Although it has been described that the second housing 220 is moved with respect to the first housing 210, the disclosure is not limited thereto. For example, the first housing 210 may be moved with respect to the second housing 220. For example, as the relative positional relationship between the first housing 210 and the second housing 220 changes, the size of the display area of the display 230 that is visually exposed outside the housing of the electronic device 101 may change.

For example, in the first state, the second housing 220 may be movable (e.g., change position) with respect to the first housing 210 in the first direction 261 of the first direction 261 and the second direction 262. For example, in the first state, the second housing 220 may not be movable in the second direction 262 with respect to the first housing 210.

For example, in the first state, the display 230 may provide the display area having the smallest size. For example, in the first state, the display area may correspond to a first area 230a. For example, although not shown in FIG. 2A, an area of the display 230 (e.g., the second area 230b of FIG. 2C), which is different from the above display area, i.e., the first area 230a, may be disposed in the first housing 210. For example, in the first state, the second area 230b may be covered by the first housing 210. For example, in the first state, the second area 230b may be moved into the first housing 210. For example, at least a portion of the second area 230b may be moved (e.g., rolled) into the first housing 210. For example, in the first state, the first area 230a may include a planar portion. For example, in the first state, a portion of the second area 230b may include a curved portion. However, embodiments of the disclosure are not limited thereto. For example, the first area 230a may include a curved portion extending from the planar portion in the first state.

For example, the first state may be referred to as a slide-in state in terms of at least a portion of the second housing 220 being positioned in the first housing 210 according to the second housing 220 that slides toward the first housing 210. For example, the first state may be referred to as a contracted state in terms of providing the display area having the smallest size. However, embodiments of the disclosure are not limited thereto.

For example, the second housing 220 may include a front camera 250-1 that obtains visual information via a portion of the first area 230a and faces in a third direction 263 parallel to the z-axis. For example, although not shown in FIG. 2A, the second housing 220 may include one or more rear cameras (e.g., the rear cameras 250-2 of FIG. 2B) that are visually exposed via a portion of the second housing 220 and face a fourth direction 264 parallel to the z-axis and opposite to the third direction 263. For example, the one or more rear cameras 250-2 may be illustrated in reference to the description(s) of FIG. 2B.

FIG. 2B is a bottom view illustrating an example electronic device in a first state.

In FIG. 2B, in the first state, one or more rear cameras 250-2 disposed in the second housing 220 may be positioned within a structure disposed in the first housing 210 for the one or more rear cameras 250-2. For example, since the one or more rear cameras 250-2 are positioned within the structure in the first state, the one or more rear cameras 250-2 may be visually exposed via the structure in the first state. The one or more rear cameras 250-2 may obtain visual information via the structure. For example, the structure may be implemented in various ways. For example, the structure may be an opening or a notch. For example, the structure may be an opening 212a in the first plate 212 of the first housing 210 surrounding at least a portion of the second housing 220. However, embodiments of the disclosure are not limited thereto.

In one or more examples, the first state may be changed to the second state.

For example, the first state (or the second state) may be changed to the second state (or the first state) via one or more intermediate states between the first state and the second state.

For example, the first state (or the second state) may be changed to the second state (or the first state) based on a defined user input. For example, the first state (or the second state) may be changed to the second state (or the first state) in response to a user input to a physical button visually exposed via a portion of the first housing 210 or a portion of the second housing 220. There is no limitation on the type of user input. For example, the user input may include a user input via a touch screen in the display area of the display 230 or a user input via a microphone of the electronic device 101. For example, the state of the electronic device 101 may be changed to the second state (or the first state) by an external force applied to the first housing 210 and/or the second housing 220.

The second state may be illustrated via the description of FIGS. 2C and 2D.

FIG. 2C is a plan view illustrating an example electronic device 101 in a second state.

In FIG. 2C, in the second state, the second housing 220 may be movable with respect to the first housing 210 in the second direction 262 of the first direction 261 and the second direction 262. For example, in the second state, the second housing 220 may not be movable in the first direction 261 with respect to the first housing 210.

For example, in the second state, the display 230 may provide the largest display area available on the electronic device 101. For example, in the second state, the display area may correspond to an area 230c including the first area 230a and the second area 230b. For example, the second area 230b included in the first housing 210 in the first state may be visually exposed in the second state. For example, in the second state, the first area 230a and the second area 230b may include a planar portion. However, embodiments of the disclosure are not limited thereto. For example, the first area 230a and/or the second area 230b may include a curved portion extending from the planar portion and positioned within the edge portion.

For example, the second state may be referred to as a slide-out state in terms of at least a portion of the second housing 220 being positioned outside the first housing 210 according to the second housing 220 that slides from the first housing 210. For example, the second state may be referred to as an expanded state having the largest display area. However, embodiments of the disclosure are not limited thereto.

For example, when the state of the electronic device 101 changes from the first state to the second state, the front camera 250-1 facing in the third direction 263 may move together with the first area 230a corresponding to the movement of the second housing 220 in the first direction 261. For example, although not illustrated in FIG. 2C, the one or more rear cameras (e.g., the rear cameras 250-2 in FIG. 2D) facing in the fourth direction 264 may move along with the second housing 220 corresponding to the movement of the second housing 220 in the first direction 261 when the state of electronic device 101 changes from the first state to the second state. For example, the relative positional relationship between the one or more rear cameras 250-2 and the structure illustrated in the description of FIG. 2B may change with respect to the movement of the one or more rear cameras 250-2. For example, the change in the relative positional relationship may be illustrated via FIG. 2D.

FIG. 2D is a bottom view illustrating an example electronic device 101 in a second state.

In FIG. 2D, in the second state, the one or more rear cameras 250-2 may be positioned outside the structure. For example, in the second state, the one or more rear cameras 250-2 may be positioned outside the opening 212a in the first plate 212. For example, because the one or more rear cameras 250-2 are positioned outside the opening 212a in the second state, the one or more rear cameras 250-2 may be visually exposed in the second state. The one or more rear cameras 250-2, positioned outside the structure, may obtain visual information. For example, since the one or more rear cameras 250-2 are positioned outside the structure in the second state, the relative positional relationship between the one or more rear cameras 250-2 and the structure (e.g., the opening 212a) in the second state may be different from the relative positional relationship between the one or more rear cameras 250-2 and the structure (e.g., the opening 212a) in the first state (e.g., FIG. 2B).

Although not shown in FIGS. 2A, 2B, 2C, and 2D, the electronic device 101 may be in any state (e.g., an intermediate state) between the first state and the second state. For example, the size of the display area in the intermediate state may be larger than the size of the display area in the first state and smaller than the size of the display area in the second state. For example, the display area in the intermediate state may correspond to an area including a portion of the first area 230a and the second area 230b. For example, in the intermediate state, a portion of the second area 230b is visually exposed, and another portion (or remaining portion) of the second area 230b may be covered by the first housing 210 or moved into the first housing 210. However, embodiments of the disclosure are not limited thereto.

The electronic device 101 may include structures for moving the second housing of the electronic device 101 (e.g., the second housing 220 of FIG. 2A, FIG. 2B, FIG. 2C, and FIG. 2D) with respect to the first housing of the electronic device 101 (e.g., the first housing 210 of FIG. 2A, FIG. 2B, FIG. 2C, and FIG. 2D). Although the embodiments describe the electronic device 101 that has a flexible display, or multiple housings that may be moved to change the state of the electronic device 101, the embodiments are not limited to these configurations. For example, the electronic device may contain a single display that is non-flexible, where one or more portions of the display may be turned on or off to change a layout size of the display. For example, in a first state, an entire area of the single display may be activated, and in a second state, half of the display may be turned off.

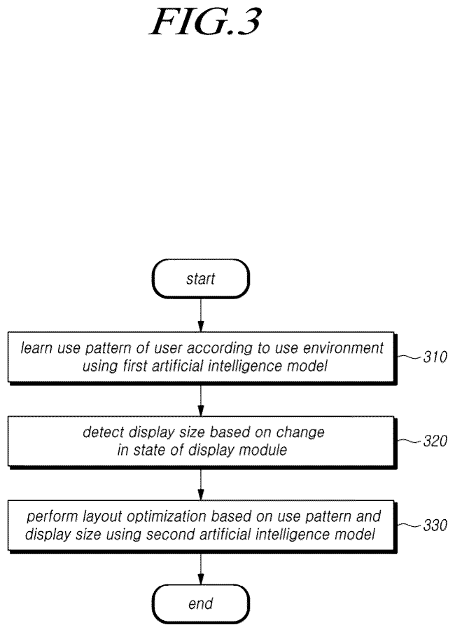

FIG. 3 is a flowchart illustrating example operations of an electronic device 101 according to one or more embodiment(s).

In FIG. 3, the electronic device 101 of the disclosure may include a display module including a flexible display that may be expanded (e.g., extended) or contracted (e.g., reduced or retracted). As described above in FIGS. 2A to 2D, the electronic device 101 may be changed to a plurality of states having different sizes of the display module.

For example, the state of the display module may include any one of a first state providing a display area having a first size, a second state providing a display area having a second size different from the first size, and an intermediate state providing a display area having a predetermined size between the first size and the second size.

The electronic device 101 of the disclosure may efficiently use a screen space by optimizing the layout of a home screen, an application (app) screen, or a lock screen as the display size expands or contracts.

In one or more examples, the electronic device 101 of the disclosure may perform layout optimization using artificial intelligence (“AI”). The AI model used by the electronic device 101 of the disclosure may be one AI model or may be implemented as a plurality of AI models. The AI model may include neural networks (or artificial neural networks) and may include a statistical learning algorithm that mimics the nerves of biology in machine learning and cognitive science. The neural network may refer to all types of models in which artificial neurons (nodes) forming a network by synaptic bonding change the strength of synaptic bonding via learning, thereby having problem-solving ability. The neuron in the neural network may include a combination of weights or biases. The neural network may include one or more layers composed of one or more neurons or nodes. For example, the device may include an input layer, a hidden layer, and an output layer. The neural network constituting the device may infer an output to be predicted from an arbitrary input by changing the weight of the neuron via learning.

According to an embodiment, AI may include generative AI. Generative AI may include a type of AI system that may generate text, images, or other media in response to prompts which are input values. Generative AI may learn the patterns and structures of input training data and then create new data with similar features.

At least one processor included in the electronic device 101 may generate a neural network, train or learn the neural network, perform a calculation based on received input data, generate an information signal based on the performed result, or retrain the neural network. The models of the neural network may include various types of models, e.g., CNN (Convolution Neural Network), such as GoogleNet, AlexNet, VGG Network, R-CNN (Region with Convolution Neural Network), RPN (Region Proposal Network), RNN (RecuREnt Neural Network), S-DNN (Stacking-based deep Neural Network), S-SDNN (State-Space Dynamic Neural Network), Deconvolution Network, DBN (Deep Belief Network), RBM (Restricted Boltzmann Machine), Fully Convolutional Network, LSTM (Long Short-Term Memory) Network, Classification Network, etc., but are not limited thereto. The processor may include one or more processors for performing calculation according to the models of the neural network. For example, the neural network may include a deep neural network. In one or more examples, the electronic device 101 may be pre-loaded with one or more pre-trained neural networks. The pre-trained neural networks may be updated based on user data (e.g., app usage and/or environment data) associated with the usage of the electronic device. In one or more examples, one or more neural networks may be trained remotely and downloaded to the electronic device 101.

The neural network may include CNN (Convolutional Neural Network), RNN (Recurrent Neural Network), perceptron, multilayer perceptron, FF (Feed Forward), RBF (Radial Basis Network), DFF (Deep Feed Forward), LSTM (Long Short Term Memory), GRU (Gated RecuREnt Unit), AE (Auto Encoder), VAE (Variational Auto Encoder), DAE (Denoising Auto Encoder), SAE (Sparse Auto Encoder), MC (Markov Chain), HN (Hopfield Network), BM (Boltzmann Machine), RBM (Restricted Boltzmann Machine), DBN (Depp Belief Network), DCN (Deep Convolutional Network), DN (Deconvolutional Network), DCIGN (Deep Convolutional Inverse Graphics Network), GAN (Generative Adversarial Network), LSM (Liquid State Machine), ELM (Extreme Learning Machine), ESN (Echo State Network), DRN (Deep Residual Network), DNC (Differentiable Neural Computer), NTM (Neural Turning Machine), CN (Capsule Network), KN (Kohonen Network) and AN (Attention Network), but one of ordinary skill in the art may understood that the neural network is not limited thereto but may include any neural network.

According to an embodiment of the disclosure, the at least one processor included in the electronic device 101 may use various AI structures and algorithms, e.g., CNN (Convolution Neural Network), such as GoogleNet, AlexNet, and/or VGG Network, R-CNN (Region with Convolution Neural Network), RPN (Region Proposal Network), RNN (RecuREnt Neural Network), S-DNN (Stacking-based deep Neural Network), S-SDNN (State-Space Dynamic Neural Network), Deconvolution Network, DBN (Deep Belief Network), RBM (Restrcted Boltzmann Machine), Fully Convolutional Network, LSTM (Long Short-Term Memory) Network, Classification Network, Generative Modeling, explainable AI, Continual AI, Representation Learning, AI for Material Design, BERT for natural language processing, SP-BERT, MRC/QA, Text Analysis, Dialog System, GPT-3, GPT-4, Visual Analytics for vision processing, Visual Understanding, Video Synthesis, Anomaly Detection, Prediction, Time-Series Forecasting, Optimization, Recommendation, and Data Creation for ResNet data intelligence, but is not limited thereto.

According to an embodiment, the electronic device 101 of the disclosure may learn a use pattern of a user according to a use environment using a first AI model (operation 310), detect a display size based on a change in the state of the display module (operation 320), and perform layout optimization based on the use pattern and the display size using a second AI model (operation 330).

According to an example, in operation 310, the electronic device 101 may learn a use pattern of the user according to the use environment using the first AI model. The electronic device 101 may learn a use pattern of the user based on the use environment using the first AI model. In one or more example, the use pattern may correspond to usage of the electronic device 101 such as the frequency of use of applications and/or the frequency of the state in which the electronic device 101 is used. The electronic device 101 may track the frequency of use of applications, the environment in which the electronic device 101 is used, and/or the frequency of the state in which the electronic device 101 is used.

According to an embodiment, the first AI model may be an analytical AI model. An analytical AI model may generally mean an AI neural network that analyzes user input information and environmental data to learn patterns and perform predictions. The analytical AI model may include a model that analyzes data and derives statistical or rule-based insights. Representative analytical AI models include supervised learning models, unsupervised learning models, and reinforcement learning models. The supervised learning model learns using input data and corresponding labels and may be mainly used to solve classification and regression problems. The unsupervised learning model may be used to analyze unlabeled data to discover hidden patterns or structures and may be mainly used for clustering and dimensionality reduction. The reinforcement learning model is a model that learns to maximize compensations as an agent interacts with the environment and may be mainly used to learn the optimal behavior policies.

According to an embodiment, the first AI model may be a generative AI model. The generative AI model may refer to an AI neural network that generates new types of data based on user input information. The generative AI model may generate various types of data such as image generation, text generation, and music generation. Representative generative AI models include generative adversarial network (GAN), variational autoencoder (VAE), and diffusion-based models. The first AI model may, as a generative AI model, learn to analyze or tune input data. For example, the first AI model may learn the user's app (or application) use pattern based on input data. For example, the first AI model may continuously analyze input data to provide a customized interface tailored to the user environment. According to an embodiment, the electronic device 101 may analyze a use environment of the electronic device 101 using the first AI model. For example, the use environment may include at least one of a display size, a place, a time, a moving speed, a network status, a remaining battery level, a weather, an ambient illuminance, ambient noise, or an ambient temperature.

For example, the electronic device 101 may determine or identify whether the display size is expanded (e.g., increased) or contracted (e.g., decreased). In one or more examples, the electronic device may include a sensor that detects whether the electronic device is expanded or contracted. The electronic device 101 may determine whether the location where the electronic device 101 is used is indoor or outdoor. For example, the electronic device 101 may determine whether the location where the electronic device 101 is used is a house or an office. The electronic device 101 may determine whether the time used by the electronic device 101 is morning, afternoon, or evening. The electronic device 101 may determine whether the user of the electronic device 101 is stopped, walking, or driving based on the moving speed. The electronic device 101 may determine whether the battery saving mode is required by analyzing the remaining battery level. The electronic device 101 may determine the current weather based on weather data and location information. The electronic device 101 may determine the brightness of the environment in which the electronic device 101 is used by sensing the ambient illuminance. The electronic device 101 may determine the sound of the environment in which the electronic device 101 is used by sensing the ambient noise. The electronic device 101 may determine a possibility of overheating of the electronic device 101 by sensing the ambient temperature. Further, the electronic device 101 may predict the current state of the user by analyzing a use environment. Additionally, the electronic device 101 may keep track of which applications are used when the electronic device 101 is an expanded or contracted state and/or when the electronic device 101 is used in a particular environment.

According to an embodiment, the electronic device 101 may learn a use pattern of the user using the first AI model. For example, the use pattern may include at least one of a type of app (or application) used, an app use frequency, an app use time, a type of widget used, a widget use frequency, a widget use time, a wallpaper setting, a screen brightness setting, or a resolution setting according to the use environment.

According to an embodiment, a use pattern of the user may be changed in response to a use environment. The electronic device 101 may predict the use pattern of the user according to a predetermined use environment by learning the use pattern of the user based on the use environment using the first AI model.

For example, the electronic device 101 may learn the types of frequently used apps according to the use environment. For example, the electronic device 101 may learn the use time or the use frequency of a specific app (or application) based on the use environment. For example, the electronic device 101 may learn the types of frequently used widgets based on the use environment. For example, the electronic device 101 may learn the use time or the use frequency of a specific widget based on the use environment. For example, the electronic device 101 may learn a method of changing the wallpaper based on the use environment. For example, the electronic device 101 may learn screen brightness settings based on the use environment. For example, the electronic device 101 may learn resolution settings based on the use environment.

According to an example, in operation 320, the electronic device 101 may detect a display size based on a change in the state of the display module. For example, the electronic device 101 may detect a change in the state of the display module using at least one sensor and a software algorithm and calculate the display size. The display module may provide different display sizes corresponding to various states. For example, the electronic device 101 may calculate a change in the size of the display area of the display module.

According to an embodiment, the electronic device 101 may change the size of the display area displaying an image to the user based on a state change of the display module (e.g., folding, unfolding, slide-in, or slide-out). For example, the operation of calculating the display size may include calculating a change in the size of the display area of the display module.

For example, the electronic device 101 may detect the display size using at least one of a position sensor, a length measurement sensor, a magnetic sensor, or a potentiometric sensor.

For example, the electronic device 101 may calculate the changed display size by measuring a physical change in the display module using an image processing software algorithm.

According to an example, in operation 330, the electronic device 101 may perform layout optimization based on the use pattern and the display size using the second AI model.

According to an embodiment, the second AI model may be a generative AI model. The generative AI model may generally refer to an AI neural network that generates new types of data depending on user input information. The generative AI model may include a model for generating an image and/or a model for generating a language. Representative image-generating models may be, for example, generative advertising network (GAN) and variable auto encoder (VAE), and diffusion-based generative models that use VAE and transformer structures. The language-generating model is a model trained to output the most statistically appropriate output based on input values. For example, representative language-generating models may be CHAT-GPT 3 and CHAT-GPT 4. There are also large multimodal models (LMMs) that may recognize various forms of input data, such as text, images, and voices, and generate corresponding new data.

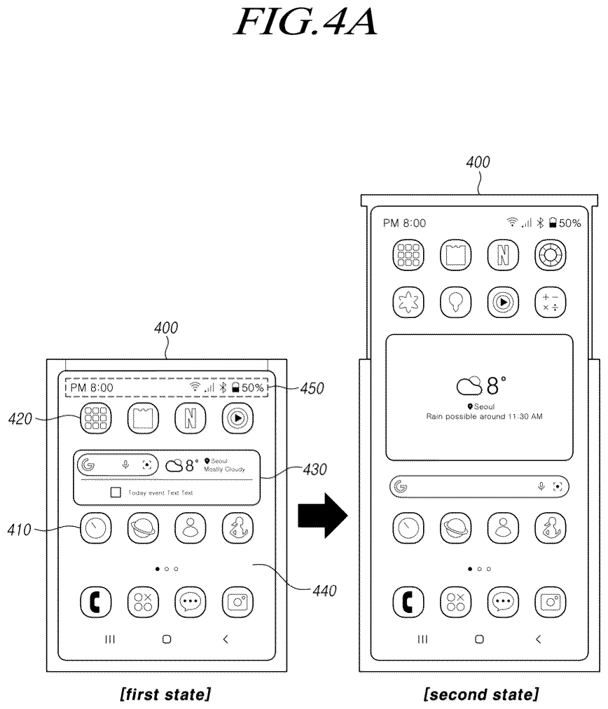

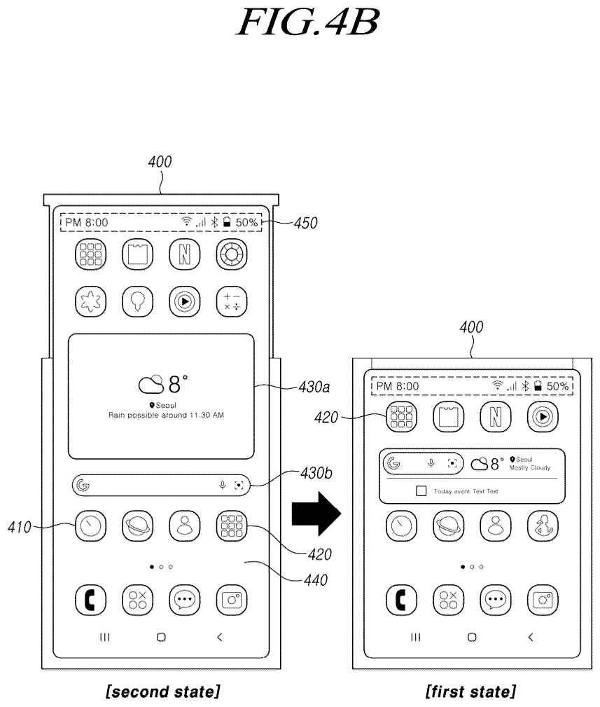

According to an embodiment, the electronic device 101 may perform the layout optimization on at least one screen of a home screen, an app screen, and a lock screen based on the use pattern and the display size. Hereinafter, performing layout optimization by the electronic device is described in detail with reference to FIGS. 4A to 6.

FIGS. 4A and 4B are views illustrating an example of layout optimization performed on a home screen of an electronic device 400 according to one or more embodiment(s).

The electronic device 400 may perform the layout optimization including at least one of app icon 410 arrangement, app icon 410 resizing, widget 430 arrangement, widget 430 configuration change, app foldering 420 setting, wallpaper 440 image change, or status bar 450 editing on a home screen. In one or more examples, arrangement of app icons and/or widgets may include rearranging the layout of the app icons and/or widgets in response to a display screen size expanding or contracting. In one or more examples, resizing of app icons and/or widgets may include resizing one or more app icons and/or widgets in response to a display screen size expanding or contracting. In one or more examples, app foldering setting may include organizing one or more app icons and/or widgets into an existing folder or a new folder.

For example, as shown in FIG. 4A, when the display size is expanded (e.g., increased), the electronic device 400 may perform at least one of app icon 410 addition, app icon 410 enlarging, widget 430 type addition, widget 430 separation, widget 430 enlarging, app foldering 420 cancellation, wallpaper 440 image expansion, or status bar 450 addition, based on the expanded display size (e.g., the size of the display area increased on the display module).

For example, as shown in FIG. 4B, when the display size is contracted (e.g., decreased), the electronic device 400 may perform at least one of the app icon 410 deletion, app icon 410 contraction, widget type deletion, widget integration, widget contraction, app foldering 420, wallpaper image contraction, or status bar 450 deletion, based on the contracted display size (e.g., the size of the reduced display area on the display module). For example, when the display size is contracted, the electronic device 400 may delete at least one of a first widget 430a and a second widget 430b based on the contracted display size. For example, when the display size is contracted, the electronic device 400 may integrate the first widget 430a and the second widget 430b into one widget based on the contracted display size.

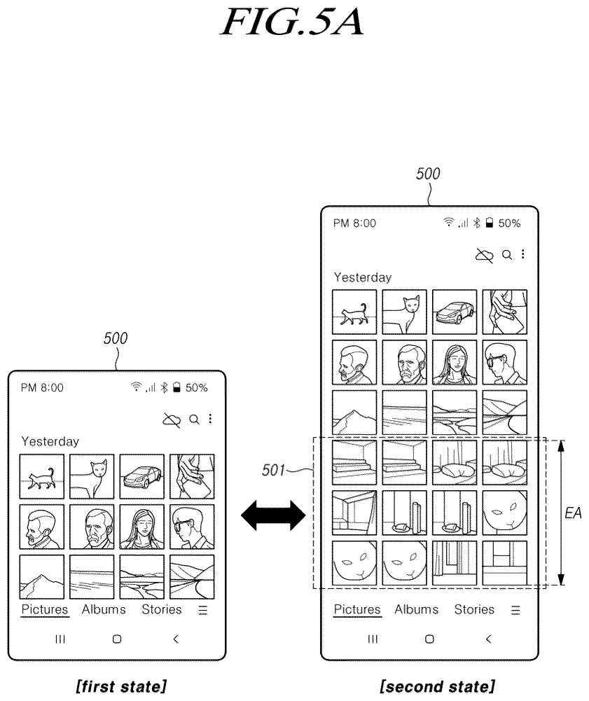

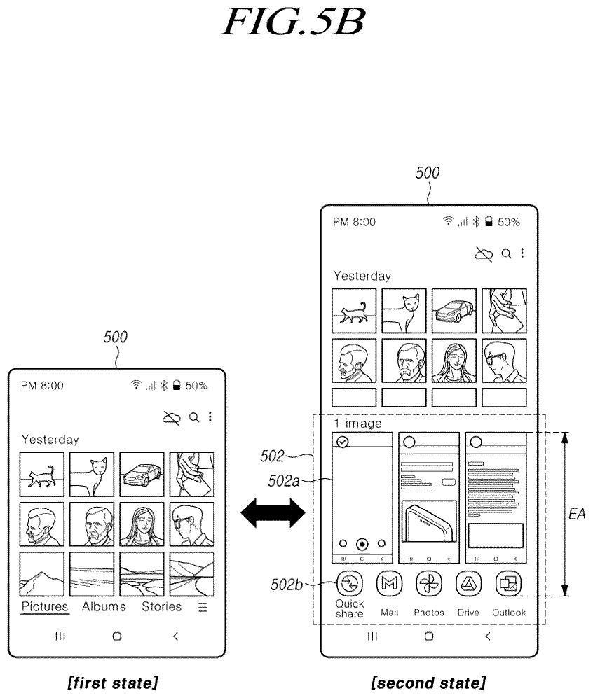

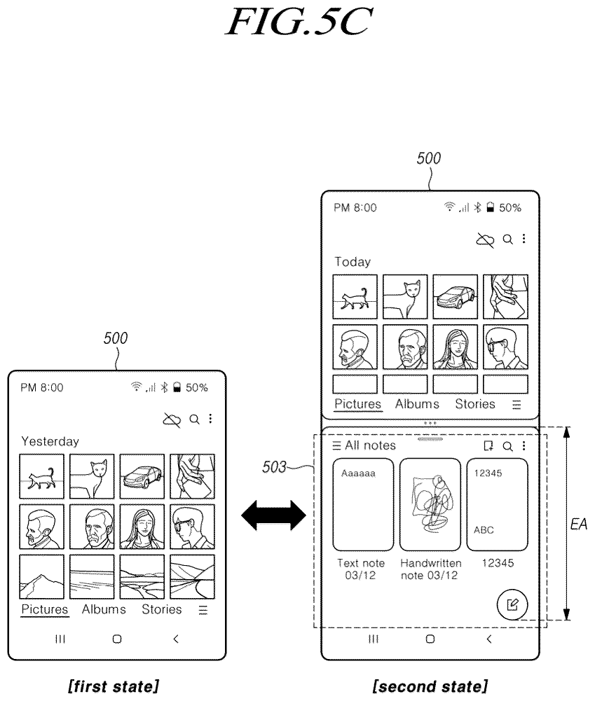

FIGS. 5A to 5C are views illustrating an example of layout optimization performed on an app screen of an electronic device 500 according to one or more embodiment(s).

In FIGS. 5A to 5C, the electronic device 500 may perform layout optimization corresponding to the display size based on an app-specific function on an app screen.

In an embodiment, when the display size is expanded (e.g., increased), the electronic device 500 may provide additional information complementing at least one content on an app screen. For example, as shown in FIG. 5A, when changing from a first state to a second state, the electronic device 500 may additionally display a content 501 of a running app in an expanded area EA. For example, as shown in FIG. 5B, when changing from a first state to a second state, the electronic device 500 may display at least one other app 502 in an expanded area EA. For example, the electronic device 500 may display another app 502a recently executed or another app 502b expected to be executed by the user. For example, as shown in FIG. 5C, when changing from a first state to a second state, the electronic device 500 may execute a multi-window and display at least one other app 503 in the expanded area EA.

In an embodiment, when the display size is contracted (e.g., decreased), the electronic device 500 may provide summary information that condenses (e.g., reduces) at least one content on an app screen. For example, when changing from a second state to a first state, the electronic device 500 may display a content with a reduced amount based on the priority of contents. For example, when changing from a second state to a first state, the electronic device 500 may display a condensed content based on the priority of contents.

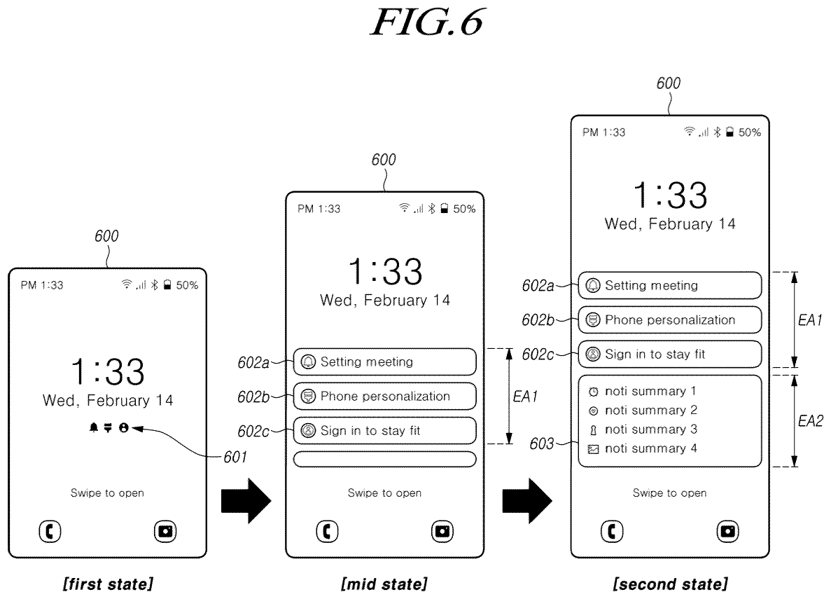

FIG. 6 is a view illustrating an example of layout optimization performed on a lock screen of an electronic device 600 according to one or more embodiment(s).

In FIG. 6, the electronic device 600 may perform layout optimization corresponding to the display size based on the notification importance on a lock screen.

In an embodiment, when the display size is expanded, the electronic device 600 may provide additional information complementing at least one content on a lock screen. For example, as shown in FIG. 6, when changing from a first state to an intermediate state, the electronic device 600 may display notification contents 602a, 602b, and 603c (EA1) corresponding to a notification icon 601 in an expanded area. For example, when changing from an intermediate state to a second state, as shown in FIG. 6, the electronic device 600 may display one or more additional notification contents 603 (EA2) corresponding to an expanded display size. The notification contents may correspond to contents regarding recently received messages (e.g., text, calls, etc.) and/or recent app notifications. The notification contents may correspond to audio (e.g. podcast) that is playing in the background.

In an embodiment, when the display size is contracted, the electronic device 600 may provide summary information that condenses at least one content on a lock screen. For example, when changing from a second state to an intermediate state, the electronic device 600 may remove notifications (e.g., additional notification 603) in the order of lowest importance, based on the contracted display size. For example, when changing from an intermediate state to a first state, the electronic device 600 may display condensed notification by replacing notification contents 602a, 602b, and 603c with notification icon 601.

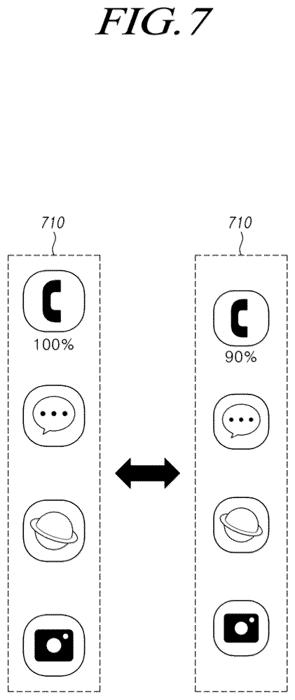

FIG. 7 is a view illustrating an example of layout optimization for an app icon 710 by an electronic device according to one or more embodiment(s).

In FIG. 7, the electronic device may adjust the size of an app icon 710. For example, when the display size is expanded, the electronic device may increase the size of the app icon 710 on a home screen to increase legibility or enhance touch accuracy. For example, if the display size expands from a reference screen ratio of 90% to a reference screen ratio of 100%, the size of the app icon 710 may increase from the reference app size 90% to the reference app size 100%, correspondingly to the change in the display size. For example, when the display size is contracted, the electronic device may contract the size of the app icon 710 to place more icons on the screen. For example, if the display size is contracted from the reference screen ratio 100% to the reference screen ratio 90%, the size of the app icon 710 may be contracted from the reference app size 100% to the reference app size 90%, correspondingly to the change in the display size. In one or more examples, instead of resizing an app icon, one or more app icons may be removed from the screen while maintaining the size of the remaining icons.

In an embodiment, the electronic device may adjust the arrangement of the app icon 710. For example, the electronic device may place the app icon 710 frequently used by the user at a predetermined position on a home screen (e.g., an upper end of the home screen or a lower end of the home screen). For example, when the display size is expanded, the electronic device may place the app icon 710 in the order of apps most frequently used by the user. For example, when the display size is contracted, the electronic device may remove the app icon 710 in the order of apps least frequently used by the user.

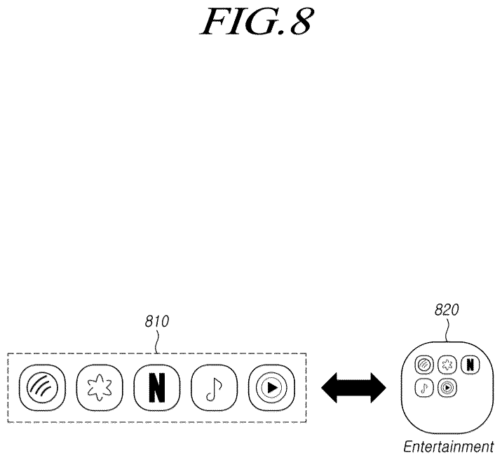

FIG. 8 is a view illustrating an example of layout optimization for an app foldering 820 by an electronic device according to one or more embodiment(s). App foldering may mean selecting and grouping app icons into a specified folder. For example, the app icons may be grouped based on similar functions or categories. For example, the electronic device may organize app icons on a home screen or an app screen by performing app foldering 820.

In FIG. 8, the electronic device may perform foldering 820 of an app icon 810 or foldering 820 cancellation of the app icon 810 based on the display size. For example, when the display size is contracted, the electronic device may perform foldering 820 of the app icon 810. For example, when the display size is expanded, the electronic device may perform foldering 820 cancellation of the app icon 810. As such, the electronic device may use a home screen or an app screen by automatically performing app foldering based on the display size. For example, when the display is contracted, the electronic device may save a screen space by automatically performing app foldering. For example, the electronic device may enhance access to important app icons by grouping similar app icons by reflecting a use pattern of the user. In one or more examples, when the electronic device is changed from the contracted state to the expanded state, the app foldering may be reversed where the apps grouped into the folder are released from the folder.

The electronic device may analyze an app use pattern of the user and automatically folder (820) a plurality of apps based on the use frequency and time. For example, the electronic device may generate an entertainment folder by foldering (820) a plurality of apps that the user mainly uses in his or her free time.

The electronic device may analyze the functions of apps mainly used by the user and automatically folder (820) apps having similar functions. For example, the electronic device may generate a video viewing folder by foldering (820) apps that display images, such as video playback apps, gallery apps, streaming apps, and OTT (Over-The-Top) apps.

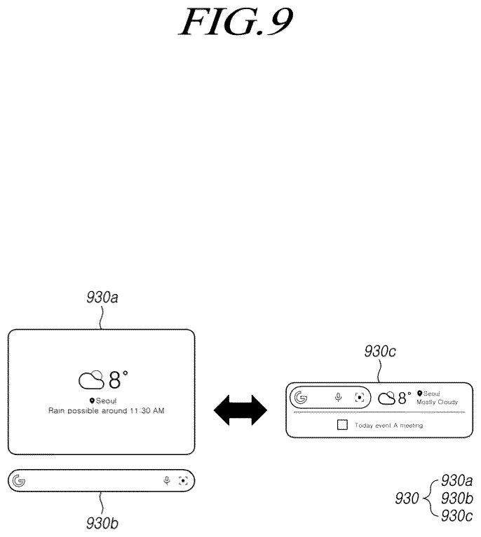

FIG. 9 is a view illustrating an example of layout optimization for a widget 930 by an electronic device according to one or more embodiment(s).

In FIG. 9, the electronic device may adjust at least one of a widget arrangement, a widget configuration, a widget type, and a widget size.

In an embodiment, when the display size is expanded or contracted, the electronic device may determine widget arrangement by reflecting the use pattern of the user. For example, the electronic device may place the widget 930 at the main position on a home screen based on the frequency of use of the widget 930. The widget 930 may be frequently used by the user. For example, the electronic device may place a weather widget and a calendar widget on the upper portion on the home screen.

In an embodiment, the electronic device may change widget 930 configuration based on the display size. For example, when the display size is expanded or contracted, the electronic device may determine widget configuration by considering (e.g., based on) the use pattern of the user. For example, when the display size is contracted, the electronic device may integrate a first widget 930a and a second widget 930b, which are frequently checked (e.g., used) by the user, into one widget 930c. For example, when the display size is expanded, the electronic device may separate the integrated widget 930c into the first widget 930a and the second widget 930b separate from each other.

In an embodiment, the electronic device may change the widget type based on the display size. For example, when the display size is expanded or contracted, the electronic device may determine a widget type by considering (e.g., based on) the use pattern of the user. For example, when the display size is expanded, the electronic device may add the widget 930 type with a high use frequency. For example, when the display size is contracted, the electronic device may remove the widget 930 type with a low use frequency.

In an embodiment, the electronic device may change the widget size based on the display size. For example, when the display size is expanded or contracted, the electronic device may determine a widget size by considering (e.g., based on) the use pattern of the user. For example, when the display size is expanded, the electronic device may increase the widget 930 size in response to the expanded ratio. For example, when the display size is contracted, the electronic device may reduce the widget 930 size in response to the contracted ratio.

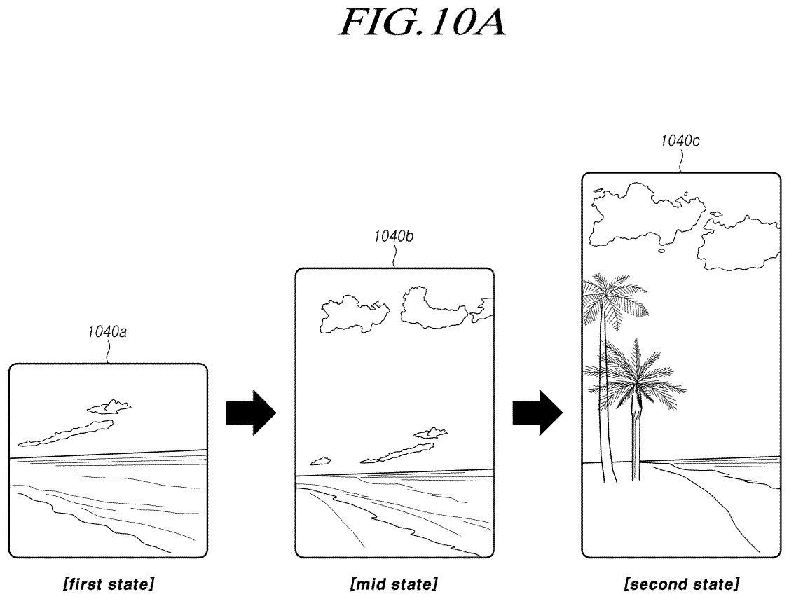

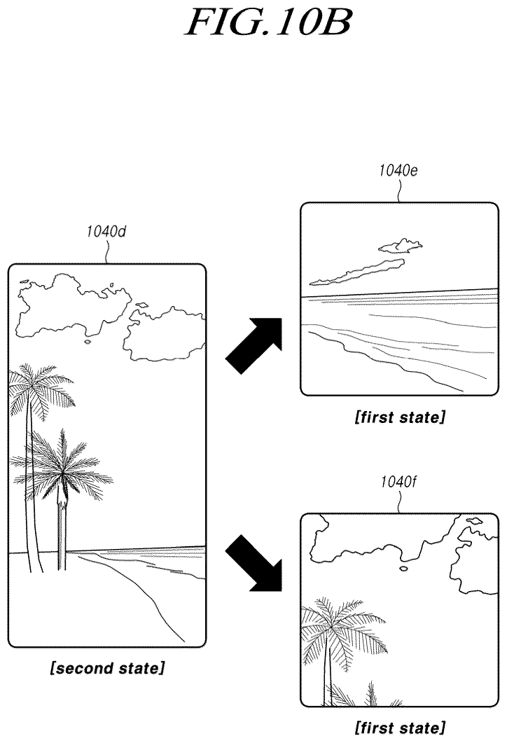

FIGS. 10A and 10B are views illustrating an example of layout optimization for a wallpaper 1040 by an electronic device according to one or more embodiment(s).

In FIGS. 10A and 10B, the electronic device may adjust the wallpaper (e.g., 1040a or 1040d) image. For example, the electronic device may expand or contract the wallpaper (e.g., 1040a or 1040d) image based on the display size.

As shown in FIG. 10A, when the display size is expanded, the electronic device may expand a wallpaper 1040a image by generating an image corresponding to the expanded area. For example, when changing from a first state to an intermediate state, the electronic device may generate a wallpaper 1040b, including an additional image for the expanded area, from the wallpaper 1040a image by using the second AI model (e.g., a generative AI model). For example, when changing from the intermediate state to a second state, the electronic device may generate a wallpaper 1040c, including an additional image for the expanded area, from the wallpaper 1040b image by using the second AI model.

According to an embodiment, the electronic device may generate a prompt (e.g., message or notification) for outputting an expanded wallpaper image based on image information about the wallpaper 1040a and expanded display size information. The electronic device may transmit an input value corresponding to an intermediate state or a second state to the second AI model based on the generated prompt. The electronic device may obtain and display an expanded wallpaper image fitting each display size as an output value of the second AI model. For example, the electronic device may provide current wallpaper image data and the size information about an expanded display to the second AI model as input values, and generate the prompt “Generate an image to fit the new screen size by expanding the current wallpaper.” The second AI model may generate an additional image corresponding to an expanded display based on the prompt, and output a wallpaper image reflecting the additional image.

As shown in FIG. 10B, when the display size is contracted, the electronic device may analyze the wallpaper 1040d image, divide the wallpaper 1040d image into predetermined sub areas, and determine the importance of each sub area. The electronic device may remove a sub area from the wallpaper 1040d image in the order of lowest importance of sub areas. For example, when it is determined that the importance of a first sub area (e.g., sea) is high, the electronic device may contract the wallpaper 1040e image focusing on the first sub area (e.g., partial image or specified area). For example, when it is determined that the importance of a second sub area (e.g., tree) is high, the electronic device may contract the wallpaper 1040f image focusing on the second sub area (e.g., partial image or specified area).

According to an embodiment, the electronic device may generate a prompt for outputting a contracted wallpaper image based on image information about the wallpaper 1040d and contracted display size information. The electronic device may transmit an input value corresponding to the contracted state to the second AI model based on the generated prompt. The electronic device may obtain and display the contracted wallpaper image fitting each display size as an output value of the second AI model. For example, the electronic device may provide the second AI model with current wallpaper image data and the size information about a contracted display as input values and generate the prompt “Generate an image to fit a new screen size by contracting the current wallpaper.” The second AI model may generate an optimized image corresponding to the contracted display based on the prompt and output a wallpaper image reflecting the optimized image.

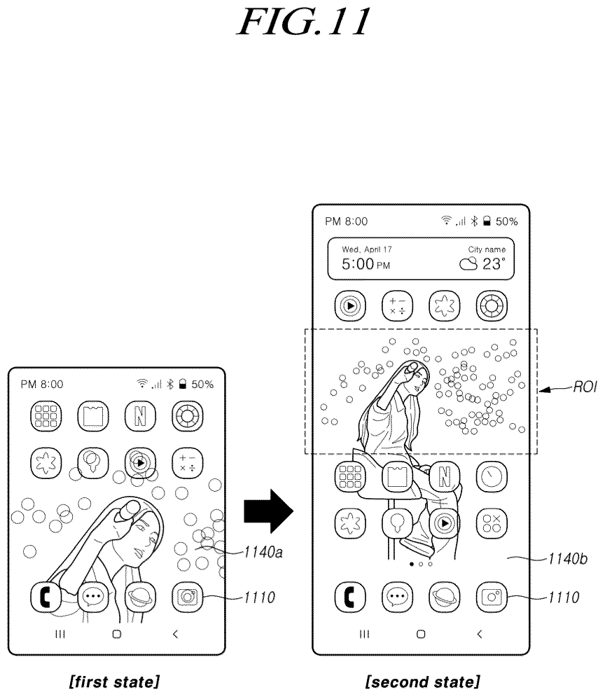

FIG. 11 is a view illustrating an example of layout optimization considering a wallpaper 1140 image by an electronic device according to one or more embodiment(s).

In FIG. 11, the electronic device may adjust app icon 1110 arrangement or widget arrangement based on the wallpaper image 1140a.

The electronic device may arrange the app icon 1110 or a widget so that a region of interest (ROI) (e.g., a person's face or a specific point) is not covered in the wallpaper image 1140a. For example, the electronic device may place the app icon 1110 or a widget while avoiding the ROI of the wallpaper image 1140a.

Further, when the wallpaper image 1140a is changed to a wallpaper image 1140b, the electronic device may re-determine the ROI of the wallpaper image 1140b and adaptively adjust the arrangement of the app icon 1110 or a widget based on the ROI.

According to an embodiment, the electronic device may analyze the wallpaper image 1140a using the first AI model (e.g., an analytical AI model). The first AI model may analyze the input wallpaper image 1140a to identify a ROI and determine an optimal layout based on the ROI. For example, the electronic device may analyze various features of the wallpaper image 1140a to evaluate the importance of a person's face, specific points, and/or background elements. The first AI model may determine the arrangement of the app icon 1110 and a widget based on the analysis result for the wallpaper image 1140a.

In one or more examples, the first AI model may use a computer vision technique to identify a ROI of the wallpaper image 1140a. For example, the first AI model may detect a person's face using a face recognition algorithm or identify important background elements using an algorithm that detects specific points. For example, based on the identification of the ROI, the electronic device may generate an optimal layout in which the app icon 1110 and the widget are arranged to avoid the region of interest. In one or more examples, the ROI may be determined by performing edge detection. For example, an edge detection process may be performed to determine one or more edges of an object, and the region comprising the one or more edges may be identified as the ROI. The app icons or widgets may be arranged such that the app icons or widgets are not overlapping with the detected edges.

Further, when the wallpaper image 1140a is changed to the wallpaper image 1140b, the first AI model may re-analyze the new wallpaper image 1140b to identify a new ROI. The electronic device may readjust the positions of the app icon 1110 and a widget in response to the new wallpaper image 1140b.

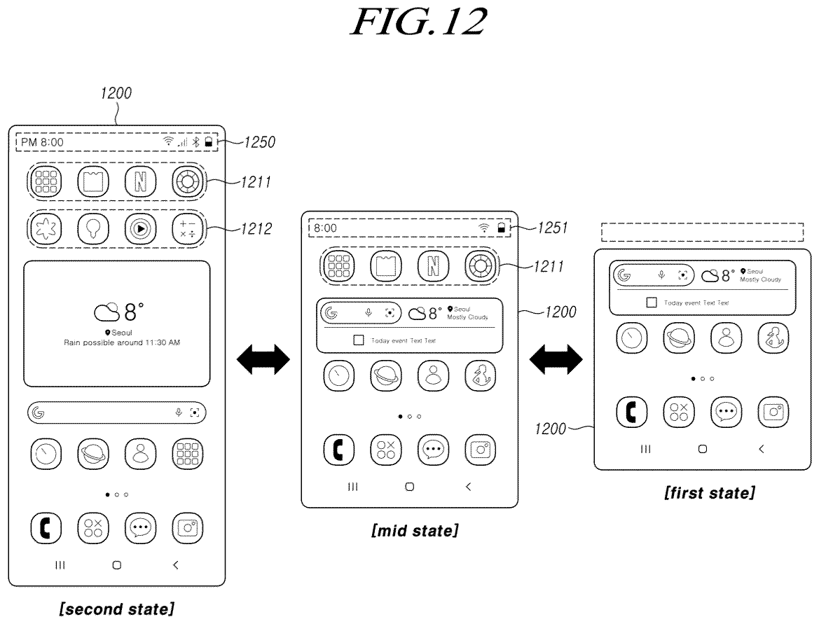

FIG. 12 is a view illustrating an example of layout optimization for a status bar 1250 by an electronic device 1200 according to one or more embodiment(s).

In FIG. 12, the electronic device 1200 may adjust contents of the status bar 1250 based on the display size.

The electronic device 1200 may adjust the size and interval of icons in the status bar 1250 based on the display size. For example, when the display size is expanded, the electronic device 1200 may increase the size and interval of icons in the status bar 1250. For example, when the display size is contracted, the electronic device 1200 may reduce the size and interval of icons in the status bar 1250.

The electronic device 1200 may change a configuration displayed on the status bar 1250 based on the display size. For example, when the display size is expanded, the electronic device 1200 may add icons in a number corresponding to the expanded area. For example, when the display size is contracted, the electronic device 1200 may remove icons from the status bar 1250 in the order of lowest frequency of use.

According to an embodiment, the electronic device 1200 may analyze a use state and a display size using the first AI model (e.g., an analytical AI model) and optimize the layout of the status bar based on the use state and the display size. For example, the first AI model may determine the optimal status bar layout corresponding to a use state by learning the user's app use pattern, app use frequency, and app use importance. For example, the first AI model may analyze apps or functions mainly used by the user and adjust the arrangement and size of status bar icons based on a change in display size.

In a second state, the electronic device 1200 may configure the status bar focusing on an icon having a high use frequency and maintain the size and interval of icons as a default size. For example, in a second state, the status bar 1250 may include at least one of a detailed time, a Wi-Fi state, a signal strength, a Bluetooth connection state, and a battery. For example, in a second state, the app screen may include a first app icon 1211 and a second app icon 1212.

In an intermediate state, the electronic device 1200 may contract the configuration of a status bar and an app screen considering the user's app use pattern, app use frequency, and app use importance in response to a contracted screen. For example, in an intermediate state, the status bar 1251 may include at least one of a simplified time, a Wi-Fi state, and a battery. For example, in an intermediate state, the app screen may only include the first app icon 1211 without the second app icon 1212.

In a first state, the electronic device 1200 may contract (e.g., decrease or reduce) the configuration of a status bar and an app screen in response to the minimized screen, considering an app use pattern of the user, an app use frequency, and app use importance. For example, in a first state, the status bars 1250 and 1251 may be removed. For example, in a first state, both the first app icon 1211 and the second app icon 1212 may be removed from the app screen.

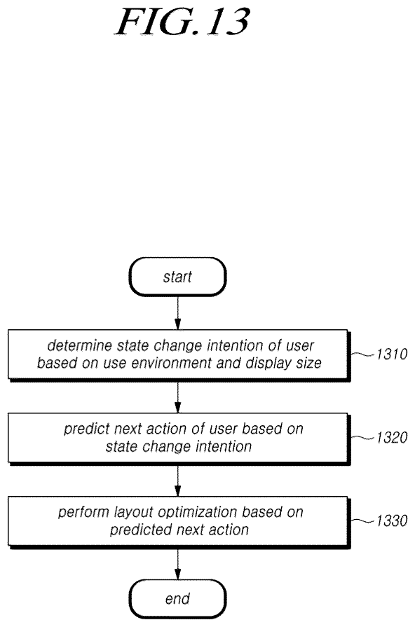

FIG. 13 is a flowchart illustrating an example operation of performing layout optimization based on a state change intention by an electronic device according to one or more embodiment(s).

In FIG. 13, the electronic device of the disclosure may determine a state change intention of the user based on a use environment and a display size (operation 1310), predict a next action of the user based on the state change intention (operation 1320), and perform the layout optimization based on the predicted next action (operation 1330).

According to an example, in operation 1310, the electronic device may determine a state change intention of the user based on a use environment and a display size.

The electronic device may determine the current state of the user or an activity of the user by analyzing a use environment of the user in real time. When the state of the display module is changed, the electronic device may determine a state change intention based on the use environment or the type of a running app. For example, the electronic device may determine a state change intention to start a call when the display size is expanded during the use of the phone app. For example, when the display size is contracted (e.g., decreased) while using a navigation app, the electronic device may determine state change intention to start driving.

According to an example, in operation 1320, the electronic device may predict a next action of the user based on the state change intention.

The electronic device may predict the kind of action the user is likely to take in a current situation based on the user's past action pattern using the second AI model (e.g., a generative AI model). For example, the electronic device may predict that the user's next action is to perform a specific activity. For example, the electronic device may predict that the user's next action is to execute a predetermined app or specific function.

According to an example, in operation 1330, the electronic device may perform the layout optimization based on the predicted next action.

The electronic device may optimize the layout of a home screen, an app screen, a lock screen, or the like based on the predicted next action of the user. For example, the electronic device may place an app, a widget, settings, etc. that are likely to be needed by the user at the optimal position on the screen according to the predicted next action. For example, the electronic device may optimize the layout so that the user may use the electronic device efficiently when performing the predicted next action by adjusting the icon size, arrangement, and widget configuration according to the display size.

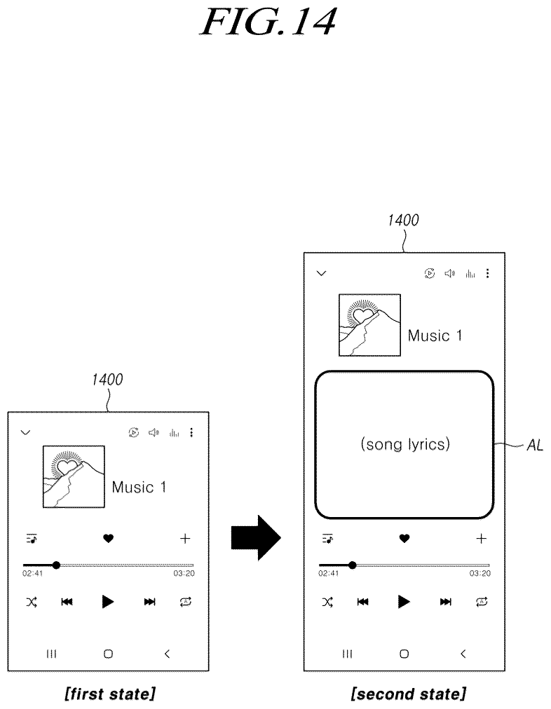

FIG. 14 is a view illustrating an example of layout optimization performed during the execution of a music app by an electronic device 1400 according to one or more embodiment(s).

In FIG. 14, the electronic device 1400 may detect a state change in which the display is expanded while the user executes the music app. The state of the display module of the electronic device 1400 may change from a first state to a second state. For example, the electronic device 1400 may determine that the user is listening to music via the music app by analyzing the use environment.

When the screen is expanded while executing the music app, the electronic device 1400 may predict that the user is highly likely to check additional information about music. As the display size is expanded, the electronic device 1400 may add a lyrics window (AL) for music to the expanded area of the music app.

According to an embodiment, the electronic device 1400 may learn a pattern in which the user mainly uses the music app by collecting and analyzing various environmental data such as the user's location, time period, network status, battery state, and ambient noise using the first AI model (e.g., an analytical AI model). For example, the electronic device 1400 may identify a time period or place in which the user listens to music and analyze the characteristics of the user's use of the music app.

According to an embodiment, the electronic device 1400 may perform layout optimization based on a use pattern of the user and a display size using the second AI model (e.g., a generative AI model). For example, based on the use pattern data learned from the first AI model, the electronic device 1400 may perform layout optimization to add a lyrics window when the screen is expanded during the execution of the music app. Specifically, the electronic device 1400 may use a current music app use pattern of the user and display expansion information as input values of the second AI model. For example, the second AI model may determine the optimal layout based on the prompt “Provide additional information when the user is listening to music and the display expands.” For example, the electronic device 1400 may add a lyrics window to the interface of the music app and provide expanded information to the user in response to the display expansion.

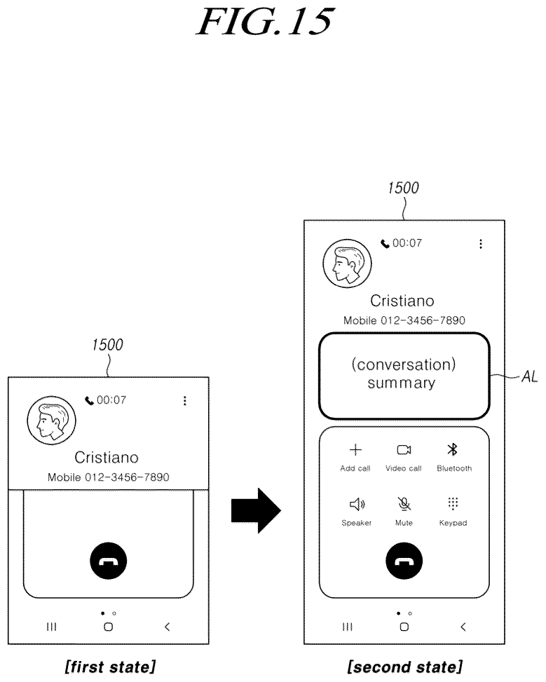

FIG. 15 is a view illustrating an example of layout optimization performed during the execution of a phone app by an electronic device 1500 according to one or more embodiment(s) of the disclosure.

In FIG. 15, the electronic device 1500 may detect a state change in which the display is expanded while the user executes the phone app. The state of the display module of the electronic device 1500 may change from a first state to a second state. For example, the electronic device 1500 may determine that the user is on the phone by analyzing the use environment.

The electronic device 1500 may predict that the user is highly likely to check additional information about the call when the screen is expanded during the execution of the phone app. As the display size is expanded, the electronic device 1500 may add a conversation summary window (AL) to provide a summary of the conversation to the expanded area of the phone app. As the display size is expanded, the electronic device 1500 may add to the expanded area of the phone app a memo window (AL) for taking a memo during a call.

According to an embodiment, the electronic device 1500 may learn a pattern in which the user mainly uses the phone app by collecting and analyzing various environmental data such as the user's location, time period, network status, battery status, and ambient noise using the first artificial intelligence model (e.g., an analytical artificial intelligence model). For example, the electronic device 1500 may identify the time period or place in which the user mainly makes a call and analyze characteristics of the user's use of the phone app.

According to an embodiment, the electronic device may perform layout optimization based on a use pattern of the user and a display size using the second AI model (e.g., a generative AI model). For example, based on the use pattern data learned from the first AI model, the electronic device 1500 may perform layout optimization to add a conversation summary window when the screen is expanded during the execution of the phone app. Specifically, the electronic device 1500 may use the user's current phone app use pattern and display expansion information as input values of the second AI model. For example, the second AI model may determine the optimal layout based on the prompt “Provide additional information when the user is on the phone and the display expands.” For example, the electronic device 1500 may add a conversation summary window and a memo window to the phone app interface in response to the display expansion and provide extend information to the user.

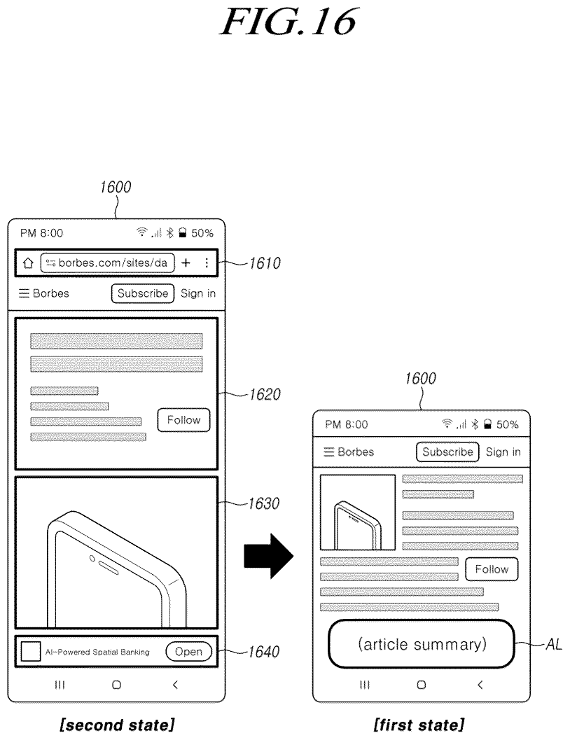

FIG. 16 is a view illustrating an example of layout optimization performed during the execution of an Internet app by an electronic device 1600 according to one or more embodiment(s).

In FIG. 16, the electronic device 1600 may detect a state change in which the display is contracted while the user executes the Internet app. The state of the display module of the electronic device 1600 may change from a second state to a first state. For example, the electronic device 1600 may determine that the user is reading an article via the Internet app by analyzing the use environment.

When the screen is contracted while executing the Internet app, the electronic device 1600 may predict that the user intends to use the screen space as efficiently as possible. As the display size is contracted, the electronic device 1600 may remove an address bar 1610 from the Internet app and display the article content 1620 in summary. As the display size is contracted, the electronic device 1600 may contract the size of an image 1630 and remove advertisement 1640 from the Internet app.

According to an embodiment, the electronic device 1600 may learn a pattern in which the user mainly uses the Internet app by collecting and analyzing various environmental data such as the user's location, time period, network status, battery status, and ambient noise using the first AI model (e.g., an analytical AI model). For example, the electronic device 1600 may identify a time period or place in which the user mainly reads articles and analyze the characteristics of the user's use of the Internet app.

According to an embodiment, the electronic device may perform layout optimization based on a use pattern of the user and a display size using the second AI model (e.g., a generative AI model). For example, the electronic device 1600 may perform layout optimization such as address bar 1610 removal and article content summarization AL when the screen is contracted during the execution of the Internet app, based on use pattern data learned from the first AI model. Specifically, the electronic device 1600 may use the user's current Internet app use pattern and display contraction information as input values of the second AI model. For example, the second AI model may determine the optimal layout based on the prompt “Optimize the layout to use the screen space as efficiently as possible when the user is reading an article and the display contracts.” For example, the electronic device 1600 may remove an address bar from the interface of the Internet app in response to the display contraction, display the content of the article in summary, and contract the image size and remove advertisements to provide an optimized screen to the user.

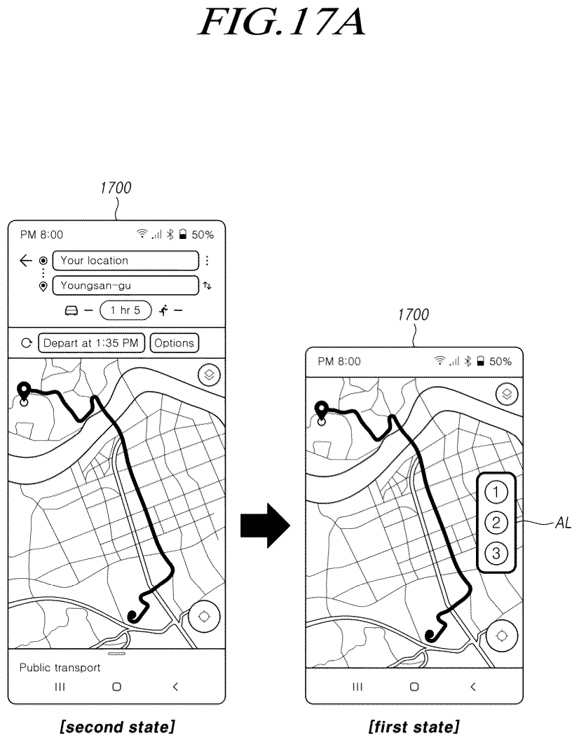

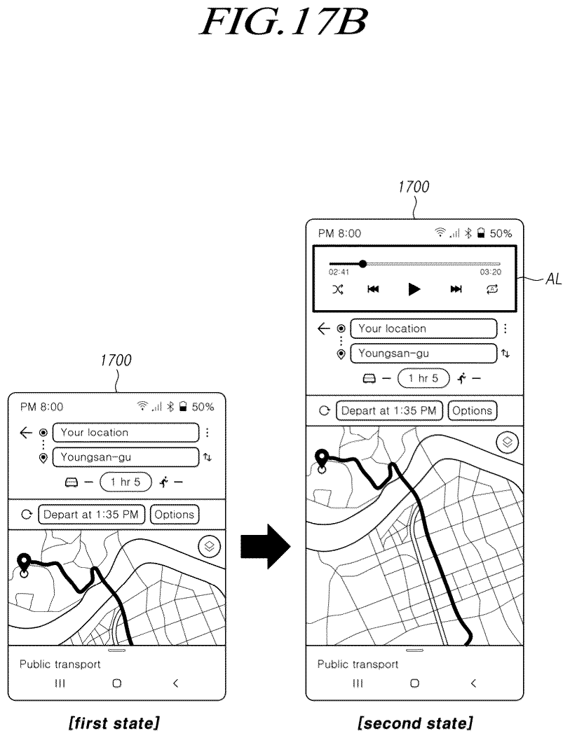

FIGS. 17A and 17B are views illustrating an example of layout optimization performed during the execution of a navigation app by an electronic device 1700 according to one or more embodiment(s).

In FIG. 17A, the electronic device 1700 may detect a state change in which the display is contracted (e.g., decreased) while the user executes the navigation app. The state of the display module of the electronic device 1700 may change from a second state to a first state. For example, the electronic device 1700 may determine that the user needs route guidance via the navigation app by analyzing the use environment.

When the screen is contracted during the execution of the navigation app, the electronic device 1700 may predict that the user is highly likely to need enhanced accessibility to route selection options. As the display size is contracted, the electronic device 1700 may display route selection options in the form of intuitive icons.

According to an embodiment, the electronic device 1700 may learn a pattern in which the user mainly uses the navigation app by collecting and analyzing various environmental data such as the user's location, time period, network status, battery status, and ambient noise using the first AI model (e.g., an analytical AI model). For example, the electronic device 1700 may identify the time period or place in which the user needs route guidance and analyze the characteristics of the user's use of the navigation app.

According to an embodiment, the electronic device may perform layout optimization based on a use pattern of the user and a display size using the second AI model (e.g., a generative AI model). For example, the electronic device 1700 may perform layout optimization that displays a route selection option in the form of an intuitive icon when the screen is contracted during the execution of the navigation app, based on the use pattern data learned from the first AI model. Specifically, the electronic device 1700 may use a current navigation app use pattern of the user and display contraction information as input values of the second AI model. For example, the second AI model may determine the optimal layout based on the prompt “Provide a route selection option in the form of an intuitive icon when the user needs route guidance and the display contracts.” For example, in response to the display contraction, the electronic device 1700 may add a route selection option in the form of an intuitive icon to the interface of the navigation app and provide enhanced accessibility to the option for the user.

In FIG. 17B, the electronic device 1700 may detect a state change in which the display is expanded during the execution of the navigation app. The state of the display module of the electronic device 1700 may change from a first state to a second state. For example, the electronic device 1700 may determine that the user is driving by analyzing the use environment.

When the screen is expanded during the execution of the navigation app, the electronic device 1700 may predict that the user intends to use the navigation app with another app simultaneously. As the display size is expanded, the electronic device 1700 may add an app (e.g., the music app) (AL) that is highly frequently used simultaneously with the navigation app to the expanded area of the navigation app.

According to an embodiment, the electronic device 1700 may learn a pattern in which the user mainly uses the navigation app by collecting and analyzing various environmental data such as the user's location, time period, network status, battery status, and ambient noise using the first AI model (e.g., an analytical AI model). For example, the electronic device 1700 may identify the time period or place in which the user uses the navigation app while driving and analyze the characteristics of the user's use of the navigation app.

According to an embodiment, the electronic device may perform layout optimization based on a use pattern of the user and a display size using the second AI model (e.g., a generative AI model). For example, the electronic device 1700 may perform layout optimization to add a music app when the screen is expanded during the execution of the navigation app based on the use pattern data learned from the first AI model. Specifically, the electronic device 1700 may use a current navigation app use pattern of the user and display expansion information as input values of the second AI model. For example, the second AI model may determine the optimal layout based on the prompt “Provide additional apps when the user is driving and the display expands.” For example, the electronic device 1700 may add a music app to the interface of the navigation app in response to the display expansion and provide the user with a function to control music and navigation simultaneously.

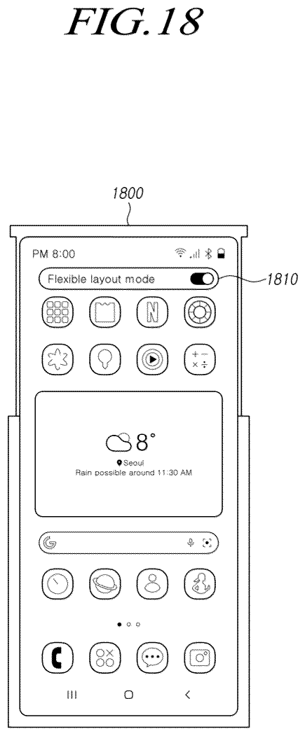

FIG. 18 is a view illustrating an example of a settings window 1810 for layout optimization of an electronic device 1800 according to one or more embodiment(s).

In FIG. 18, the electronic device 1800 may provide a settings window 1810 for setting (e.g., configuration) whether to apply layout optimization. For example, the user may activate (e.g., on) a layout optimization mode or deactivate (e.g., off) the layout optimization mode using the settings window 1810.

For example, the settings window 1810 may be provided on the settings app. For example, the settings window 1810 may be provided as a quick setting menu in a status bar. For example, the settings window 1810 may be displayed in the form of a pop-up window.

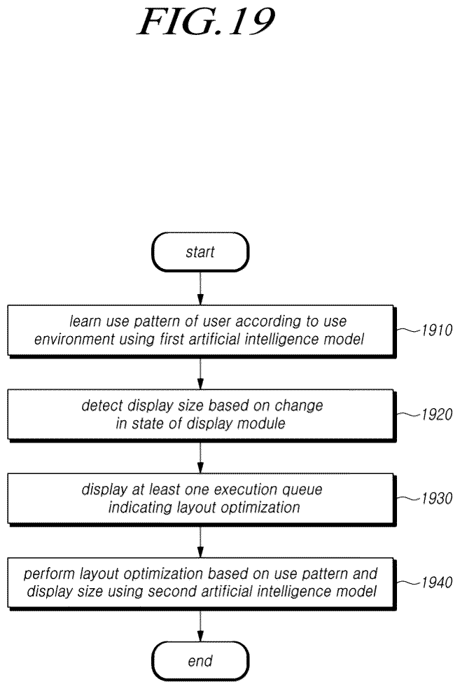

FIG. 19 is a flowchart illustrating an operation of displaying a layout optimization execution queue by an electronic device according to one or more embodiment(s).

In FIG. 19, the electronic device of the disclosure may display at least one layout optimization execution queue indicating the performing of the layout optimization via the display module. The electronic device of the disclosure may display at least one layout optimization execution queue indicating the execution of the layout optimization via the display module.

According to an embodiment, the electronic device may learn a use pattern of the user based on the use environment using the first AI model (operation 1910), detect a display size based on a change in the state of the display module (operation 1920), display at least one execution queue indicating the layout optimization to the user (operation 1930), and perform layout optimization based on the use pattern and the display size using the second AI model (operation 1940).

According to an example, in operation 1910, the electronic device may learn a use pattern of the user based on the use environment using the first AI model.

The electronic device may analyze the use environment of the electronic device using the first AI model. For example, the use environment may include at least one of a display size, a place, a time, a moving speed, a network status, a remaining battery level, a weather, an ambient illuminance, ambient noise, or an ambient temperature.

The electronic device may learn a use pattern of the user using the first AI model. For example, the use pattern may include at least one of a type of app used, an app use frequency, an app use time, a type of widget used, a widget use frequency, a widget use time, a wallpaper setting, a screen brightness setting, or a resolution setting according to the use environment.

According to an example, in operation 1920, the electronic device may detect a display size based on a change in the state of the display module. For example, the electronic device may detect a display size change using at least one sensor and a software algorithm and calculate the display size.

According to an embodiment, the display module may include a slidable display. The slidable display may have a structure in which the display module expands or contracts. For example, the slidable display may change the display area as the side surface of the display extends or contracts via a sliding mechanism. For example, as the display module slides out, the screen of the electronic device may widen (e.g., expand) and the display area may increase. For example, as the display module of the electronic device slides in, the screen may decrease and the display area may decrease.

When the display module slides out, the electronic device may provide additional information to the user by arranging more widgets and icons on the display. For example, if the display module slides out while a music app is used, the electronic device may additionally provide lyrics information by adding a lyrics window.

When the display module slides in, the electronic device may increase display efficiency by removing unnecessary icons from the display or performing app foldering. For example, if the display module slides in while a navigation app is used, the electronic device may display a route selection option in the form of an icon, thereby increasing accessibility to the route selection option.

According to an embodiment, the display module may include a foldable display. The foldable display may have a structure in which the display module folds or unfolds. For example, in the foldable display, the display area may be changed as the display is folded into at least two portions. For example, as the display module is unfolded, the screen of the electronic device may be widened (e.g., increased) and the display area may increase. For example, as the display module of the electronic device is folded, the screen may decrease and the display area may decrease.

When the display module is unfolded, the electronic device may provide additional information to the user by arranging more widgets and icons on the display. For example, if the display module unfolds while a phone app is used, the electronic device may provide the user with necessary and/or additional information by adding a conversation summary window and a memo window.

When the display module is folded, the electronic device may increase display efficiency by removing unnecessary icons from the display or performing app foldering. For example, if the display module folds while an Internet app is used, the electronic device may efficiently utilize the screen space by removing an address bar and summarizing the content of an article.

According to an embodiment, the electronic device may calculate a change in the size of the display area of the display module according to a state change (e.g., folding, unfolding, slide-in, and slide-out) of the display module.

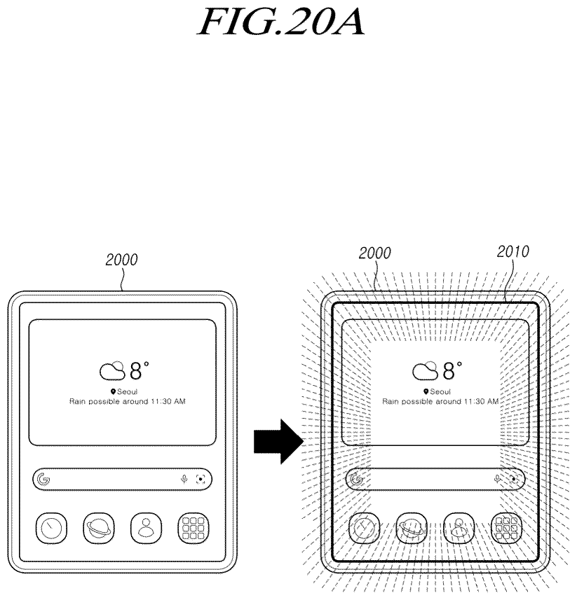

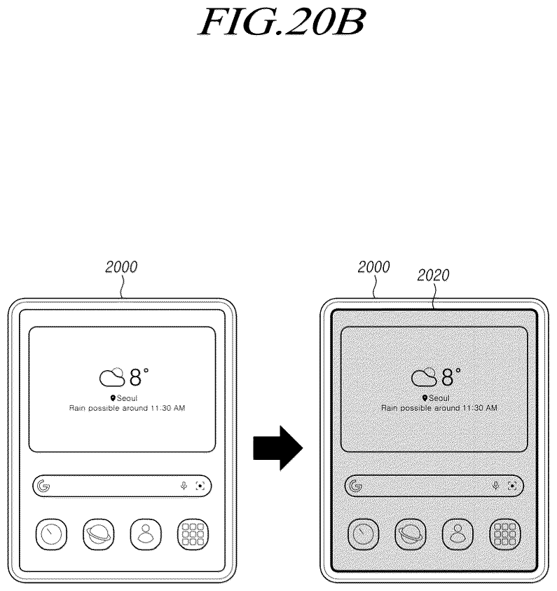

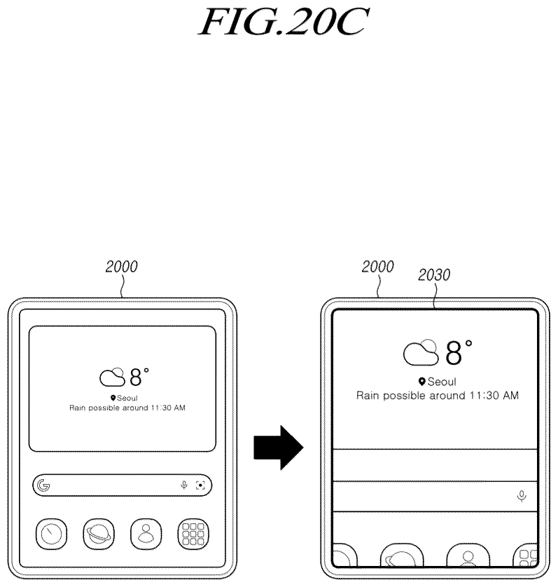

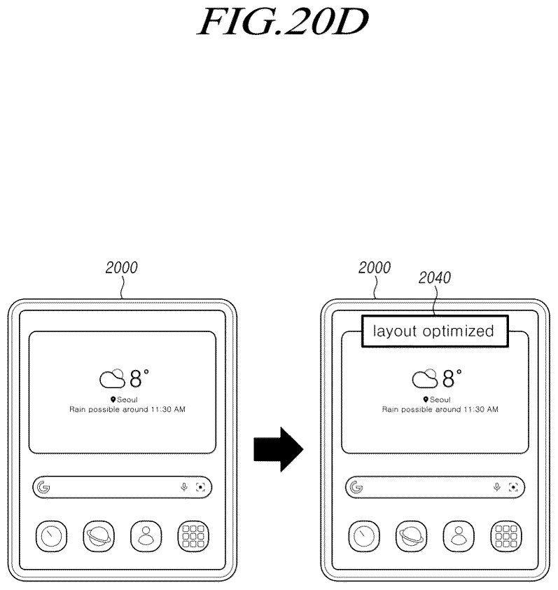

According to an example, in operation 1930, the electronic device 2000 may display at least one layout optimization execution queue indicating performing layout optimization via the display module. Hereinafter, operation 1930 of the electronic device 2000 is described in detail with reference to FIGS. 20A to 20D.

FIGS. 20A to 20D are views illustrating an example of a layout optimization execution queue of an electronic device 2000 according to one or more embodiment(s).

In FIGS. 20A to 20D, the electronic device 2000 may provide various visual effects of notifying the user of the performing (e.g., execution) of layout optimization via the display module. The electronic device 2000 may provide the user with a notification of the layout optimization execution by displaying the layout optimization execution queue. For example, the electronic device 2000 may display at least one layout optimization execution queue of a border effect, a flickering effect, an effect of expanding and restoring the screen, or a message notification.

For example, as shown in FIG. 20A, the electronic device 2000 may display a border effect 2010 in which the edge of the display module is highlighted in a specific color when layout optimization is performed or executed. The border effect 2010 may be turned on for a predetermined time and may disappear as layout optimization is completed.

For example, as shown in FIG. 20B, the electronic device 2000 may display a flickering effect 2020 in which the display module temporarily blinks when layout optimization is performed. The flickering effect 2020 may be repeatedly provided and may disappear as layout optimization is completed.

For example, as shown in FIG. 20C, the electronic device 2000 may display an effect 2030 of expanding and restoring the screen of the display module when layout optimization is performed. When the effect 2030 of expanding and restoring the screen of the display module is displayed, the screen may be expanded for a predetermined time and the screen may be restored as the layout optimization is completed.

For example, as shown in FIG. 20D, the electronic device 2000 may display a message notification 2040 in a predetermined area of the display module when layout optimization is performed. The message notification 2040 may be displayed for a predetermined time and may disappear as layout optimization is completed.

According to an example, in operation 1940, the electronic device may perform layout optimization based on the use pattern and the display size using the second AI model.

The electronic device may perform the layout optimization on at least one screen among a home screen, an app screen, and a lock screen based on the use pattern and the display size.

The electronic device may perform the layout optimization including at least one of app icon arrangement, app icon resizing, widget arrangement, widget configuration change, app foldering setting, wallpaper image change, or status bar editing on the home screen.

As described above, according to the disclosure, the electronic device and the method for operating the same may efficiently use a screen space by optimizing the layout of a home screen, an app screen, or a lock screen as the display size is expanded or contracted.

Further, according to the disclosure, an electronic device and a method for operating the same may provide a user interface adaptive to intention of the user to change the screen size or a use scenario for each context by learning use patterns of the user and analyzing various use environments using an AI model.

Further, according to the disclosure, an electronic device and a method for operating the same may inform the user of a change in a user interface according to layout optimization by displaying a layout optimization execution queue via the display when layout optimization is performed.

Therefore, according to the disclosure, an electronic device and a method for operating the same may increase the usability of a slidable electronic device and maximize user convenience and user satisfaction.

However, since this has been described above, no duplicate description is given.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an aspect of the disclosure, an electronic device comprises: a display module comprising a flexible display having a display size that is expandable and contractible; memory storing instructions; and at least one processor operatively coupled to the memory and the display module, in which the instructions, when executed by at least one processor, cause the electronic device to: determine, using a first artificial intelligence model, a use pattern of a user of the electronic device according to a use environment, detect the display size of the flexible display based on a change in a state of the display module, and perform, using a second artificial intelligence model, layout optimization based on the use pattern and the display size.

According to an aspect of the disclosure, the instructions, when executed individually and/or collectively by at least one processor, cause the electronic device to perform the layout optimization comprising at least one of (i) application icon arrangement, (ii) application icon resizing, (iii) widget arrangement, (iv) widget configuration change, (v) application foldering setting, (vi) wallpaper image change, or (vii) status bar editing on at least one screen among a home screen, an application screen, or a lock screen.

According to an aspect of the disclosure, the state of the display module comprises one of: a first state providing a first display area of the flexible display having a first size, a second state providing a second display area of the flexible display having a second size different from the first size, and an intermediate state providing a third display area of the flexible display having a predetermined size between the first size and the second size.

According to an aspect of the disclosure, the instructions, when executed individually and/or collectively by at least one processor, cause the electronic device to analyze the use environment comprising at least one of (i) the display size, (ii) a place, (iii) a time, (iv) a moving speed, (v) a network status, (vi) a remaining battery level, (vii) a weather, (viii) an ambient illuminance, (ix) ambient noise, or (x) an ambient temperature.

According to an aspect of the disclosure, the instructions, when executed individually and/or collectively by at least one processor, cause the electronic device to determine the use pattern comprising at least one of (i) a type of a used application, (ii) an application use frequency, (iii) application app use time, (iv) a type of a used widget, (v) a widget use frequency, (vi) a widget use time, (vii) a wallpaper setting, (viii) a screen brightness setting, or (ix) a resolution setting according to the use environment.

According to an aspect of the disclosure, the instructions, when executed individually and/or collectively by at least one processor, cause the electronic device to, based on the display size being expanded, perform at least one of (i) application icon addition, (ii) application icon enlarging, (iii) widget type addition, (iv) widget separation, (v) widget enlarging, (vi) application foldering cancellation, (vii) wallpaper image expansion, or (viii) status bar addition, based on an expanded display size.

According to an aspect of the disclosure, the instructions, when executed individually and/or collectively by at least one processor, cause the electronic device to, based on the display size being contracted, perform at least one of (i) application icon deletion, (ii) application icon contraction, (iii) widget type deletion, (iv) widget integration, (v) widget contraction, (vi) application foldering, (vii) wallpaper image contraction, or (viii) status bar deletion, based on a contracted display size.

According to an aspect of the disclosure, the instructions, when executed individually and/or collectively by at least one processor, cause the electronic device to: based on the display size being expanded, provide additional information complementing at least one content among a home screen, an application screen, or a lock screen, and based on the display size being contracted, provide summary information compressing the at least one content among the home screen, the application screen, or the lock screen.

According to an aspect of the disclosure, in which the instructions, when executed individually and/or collectively by at least one processor, cause the electronic device to: determine a state change intention of the user based on the use environment and the display size, predict a next action of the user based on the state change intention, and perform the layout optimization based on the predicted next action.

According to an aspect of the disclosure, based on the layout optimization being performed, the instructions, when executed individually and/or collectively by at least one processor, cause the electronic device to display at least one layout optimization execution queue indicating the performing of the layout optimization via the display module.

According to an aspect of the disclosure, a method for operating an electronic device comprises: determining, using a first artificial intelligence model, a use pattern of a user of the electronic device according to a use environment; detecting a display size of a flexible display of a display module based on a change in a state of the display module, wherein the display size of the flexible display is expandable and contractible; and performing, using a second artificial intelligence model, layout optimization based on the use pattern and the display size.

According to an aspect of the disclosure, in which the performing the layout optimization comprises at least one of (i) application icon arrangement, (ii) application icon resizing, (iii) widget arrangement, (iv) widget configuration change, (v) application foldering setting, (vi) wallpaper image change, or (vii) status bar editing on at least one screen among a home screen, an application screen, or a lock screen.

According to an aspect of the disclosure, the state of the display module comprises one of: a first state providing a first display area of the flexible display having a first size, a second state providing a second display area of the flexible display having a second size different from the first size, and an intermediate state providing a third display area of the flexible display having a third size between the first size and the second size.

According to an aspect of the disclosure, the determining the use pattern of the user according to the use environment comprises analyzing the use environment comprising at least one of (i) the display size, (ii) a place, (iii) a time, (iv) a moving speed, (v) a network status, (vi) a remaining battery level, (vii) a weather, (viii) an ambient illuminance, (ix) ambient noise, or (x) an ambient temperature.

According to an aspect of the disclosure, the determining the use pattern of the user according to the use environment comprises determining the use pattern comprising at least one of a type of (i) a used application, (ii) an application use frequency, (iii) an application use time, (iv) a type of a used widget, (v) a widget use frequency, (vi) a widget use time, (vii) a wallpaper setting, (viii) a screen brightness setting, or (ix) a resolution setting according to the use environment.

According to an aspect of the disclosure, the performing the layout optimization comprises, based on the display size being expanded, performing at least one of (i) application icon addition, (ii) application icon enlarging, (iii) widget type addition, (iv) widget separation, (v) widget enlarging, (vi) application foldering cancellation, (vii) wallpaper image expansion, or (viii) status bar addition, based on an expanded display size.

According to an aspect of the disclosure, the performing the layout optimization comprises, based on the display size being contracted, performing at least one of (i) application icon deletion, (ii) application icon contraction, (iii) widget type deletion, (iv) widget integration, (v) widget contraction, (vi) application foldering, (vii) wallpaper image contraction, or (viii) status bar deletion, based on a contracted display size.

According to an aspect of the disclosure, in which the performing the layout optimization comprises: based on the display size being expanded, providing additional information complementing at least one content among a home screen, an application screen, or a lock screen; and based on the display size being contracted, providing summary information condensing the at least one content among the home screen, the application screen, or the lock screen.

According to an aspect of the disclosure, the method further comprises: determining a state change intention of the user based on the use environment and the display size; predicting a next action of the user based on the state change intention; and performing the layout optimization based on the predicted next action.

According to an aspect of the disclosure, the performing the layout optimization comprises displaying at least one layout optimization execution queue indicating the performing of the layout optimization via the display module.

What is claimed is:

1. An electronic device comprising:
a display module comprising a flexible display having a display size that is expandable and contractible;
memory storing instructions; and
at least one processor operatively coupled to the memory and the display module,
wherein the instructions, when executed individually and/or collectively by at least one processor, cause the electronic device to:
determine, using a first artificial intelligence model, a use pattern of a user of the electronic device according to a use environment,
detect the display size of the flexible display based on a change in a state of the display module, and
perform, using a second artificial intelligence model, layout optimization based on the use pattern and the display size.

2. The electronic device of claim 1, wherein the instructions, when executed individually and/or collectively by at least one processor, cause the electronic device to perform the layout optimization comprising at least one of application icon arrangement, application icon resizing, widget arrangement, widget configuration change, application foldering setting, wallpaper image change, or status bar editing on at least one screen among a home screen, an application screen, or a lock screen.

3. The electronic device of claim 1, wherein the state of the display module comprises one of:
a first state providing a first display area of the flexible display having a first size,
a second state providing a second display area of the flexible display having a second size different from the first size, and
an intermediate state providing a third display area of the flexible display having a third size between the first size and the second size.

4. The electronic device of claim 1, wherein the instructions, when executed individually and/or collectively by at least one processor, cause the electronic device to analyze the use environment comprising at least one of the display size, a place, a time, a moving speed, a network status, a remaining battery level, a weather, an ambient illuminance, ambient noise, or an ambient temperature.

5. The electronic device of claim 1, wherein the instructions, when executed individually and/or collectively by at least one processor, cause the electronic device to determine the use pattern comprising at least one of a type of a used application, an application use frequency, an application use time, a type of a used widget, a widget use frequency, a widget use time, a wallpaper setting, a screen brightness setting, or a resolution setting according to the use environment.

6. The electronic device of claim 1, wherein the instructions, when executed individually and/or collectively by at least one processor, cause the electronic device to, based on the display size being expanded, perform at least one of application icon addition, application icon enlarging, widget type addition, widget separation, widget enlarging, application foldering cancellation, wallpaper image expansion, or status bar addition, based on an expanded display size.

7. The electronic device of claim 1, wherein the instructions, when executed individually and/or collectively by at least one processor, cause the electronic device to, based on the display size being contracted, perform at least one of application icon deletion, application icon contraction, widget type deletion, widget integration, widget contraction, application foldering, wallpaper image contraction, or status bar deletion, based on a contracted display size.

8. The electronic device of claim 1, wherein the instructions, when executed individually and/or collectively by at least one processor, cause the electronic device to:
based on the display size being expanded, provide additional information complementing at least one content among a home screen, an application screen, or a lock screen, and
based on the display size being contracted, provide summary information compressing the at least one content among the home screen, the application screen, or the lock screen.

9. The electronic device of claim 1, wherein the instructions, when executed individually and/or collectively by at least one processor, cause the electronic device to:
determine a state change intention of the user based on the use environment and the display size,
predict a next action of the user based on the state change intention, and
perform the layout optimization based on the predicted next action.

10. The electronic device of claim 1, wherein the instructions, when executed individually and/or collectively by at least one processor, cause the electronic device to, based on the layout optimization being performed, display at least one layout optimization execution queue indicating the performing of the layout optimization via the display module.

11. A method for operating an electronic device, the method comprising:
determining, using a first artificial intelligence model, a use pattern of a user of the electronic device according to a use environment,
detecting a display size of a flexible display of a display module based on a change in a state of the display module, wherein the display size of the flexible display is expandable and contractible, and
performing, using a second artificial intelligence model, layout optimization based on the use pattern and the display size.

12. The method of claim 11, wherein the performing the layout optimization comprises at least one of application icon arrangement, application icon resizing, widget arrangement, widget configuration change, application foldering setting, wallpaper image change, or status bar editing on at least one screen among a home screen, an application screen, or a lock screen.

13. The method of claim 11, wherein the state of the display module comprises one of:
a first state providing a first display area of the flexible display having a first size,
a second state providing a second display area of the flexible display having a second size different from the first size, and
an intermediate state providing a third display area of the flexible display having a third size between the first size and the second size.

14. The method of claim 11, wherein the determining the use pattern of the user according to the use environment comprises analyzing the use environment comprising at least one of the display size, a place, a time, a moving speed, a network status, a remaining battery level, a weather, an ambient illuminance, ambient noise, or an ambient temperature.

15. The method of claim 11, wherein the determining the use pattern of the user according to the use environment comprises determining the use pattern comprising at least one of a type of a used application, an application use frequency, an application use time, a type of a used widget, a widget use frequency, a widget use time, a wallpaper setting, a screen brightness setting, or a resolution setting according to the use environment.

16. The method of claim 11, wherein the performing the layout optimization comprises, based on the display size being expanded, performing at least one of application icon addition, application icon enlarging, widget type addition, widget separation, widget enlarging, application foldering cancellation, wallpaper image expansion, or status bar addition, based on an expanded display size.

17. The method of claim 11, wherein the performing the layout optimization comprises, based on the display size being contracted, performing at least one of application icon deletion, application icon contraction, widget type deletion, widget integration, widget contraction, application foldering, wallpaper image contraction, or status bar deletion, based on a contracted display size.

18. The method of claim 11, wherein the performing the layout optimization comprises:
based on the display size being expanded, providing additional information complementing at least one content among a home screen, an application screen, or a lock screen, and
based on the display size being contracted, providing summary information condensing the at least one content among the home screen, the application screen, or the lock screen.

19. The method of claim 11, further comprising:
determining a state change intention of the user based on the use environment and the display size,
predicting a next action of the user based on the state change intention, and
performing the layout optimization based on the predicted next action.

20. The method of claim 11, wherein the performing the layout optimization comprises displaying at least one layout optimization execution queue indicating the performing of the layout optimization via the display module.
